(19) United States
(12) Patent Application Publication
(10) Pub. No.: US 2024/0349379 A1
(43) Pub. Date: Oct. 17, 2024

(54) METHODS, ARCHITECTURES, APPARATUSES AND SYSTEMS FOR CONNECTION ESTABLISHMENT AND CONFIGURATION FOR MULTI-HOP RELAYS

(71) Applicant: InterDigital Patent Holdings, Inc., Wilmington, DE (US)

(72) Inventors: Martino Freda, Laval (CA); Oumer Teyeb, Montreal (CA); Tuong Hoang, Montreal (CA); Jaya Rao, Montreal (CA); Moon-il Lee, Melville, NY (US)

(21) Appl. No.: 18/294,211

(22) PCT Filed: Aug. 3, 2022
(86) PCT No.: PCT/US2022/039260

§ 371 Date: Feb. 1, 2024

Related U.S. Application Data
(60) Provisional application No. 63/228,859, filed on Aug. 3, 2021.

(51) Int. Cl. H04W 76/18; H04W 88/04

(52) U.S. Cl. CPC H04W 76/18; H04W 88/04

(57) ABSTRACT

Procedures, methods, architectures, apparatuses, systems, devices, and computer program products may be used to communicate via a multi-hop relay path. A wireless transmit/receive unit (WTRU) may be configured to operate as a sidelink (SL) relay WTRU which may be located inside or outside of network coverage. The SL relay WTRU may determine any of whether to perform connection establishment, a connection establishment timer, and/or an adaptation layer configuration based on any of a cumulative weight value (e.g., broadcast by another WTRU), a measured channel busy ratio (CBR) associated with the multi-hop relay path, and/or a quality of service (QoS) associated with data to be relayed (e.g., from a remote WTRU or a base station).

### CROSS-REFERENCE TO RELATED APPLICATIONS

This application claims the benefit of U.S. Provisional Patent Application No. 63/228,859 filed 3 Aug. 2021, which is incorporated herein by reference.

### TECHNICAL FIELD

The present disclosure is generally directed to the fields of communications, software and encoding, including, for example, to methods, architectures, apparatuses, systems directed to connection establishment and configuration for multi-hop relays.

### SUMMARY

As an example, a wireless transmit/receive unit (WTRU) may implement a method for multi-hop relay communications. The WTRU may serve as a relay on a multi-hop path between another (e.g., remote) WTRU and a base station. One or more other (e.g., intermediate) relay WTRUs may be disposed as part of the multi-hop path between the relay WTRU and the remote WTRU and/or the relay WTRU and the base station. The WTRU may receive information indicating a configuration of sidelink (SL) resources. The WTRU (e.g., as a relay WTRU associated with the multi-hop path) may receive, via the SL resources, a first SL transmission from a remote WTRU. The (e.g., relay) WTRU may initiate (e.g., upon receiving the first SL transmission) a connection establishment procedure to a base station. The (e.g., relay) WTRU may determine that a failure has occurred in the connection establishment procedure. The (e.g., relay) WTRU may send, via the SL resources, a second SL transmission to the remote WTRU. The second SL transmission may in some instances include (1) information indicating the failure in the connection establishment procedure is associated with a second relay WTRU, or in other instances include (2) information indicating the failure in the connection establishment procedure is associated with the base station.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating a system overview for a user plane radio protocol stack for a L2 evolved WTRU-to-Network relay using a PC5 interface;

FIG. 3 is a diagram illustrating a system overview for a control plane radio protocol stack for a L2 evolved WTRU-to-Network relay using a PC5 interface;

FIG. 4 is a system diagram illustrating a single hop relay example;

FIG. 5 is a system diagram illustrating a multi-hop relay example;

FIG. 6 is a system diagram illustrating another multi-hop relay example;

FIG. 7 is a diagram illustrating a RRC establishment procedure between a WTRU and a network;

FIG. 8 is a diagram illustrating a RRC re-establishment procedure between a WTRU and a network;

FIG. 9 is a diagram illustrating a RRC release procedure between a WTRU and a network;

FIG. 10 is a diagram illustrating a RRC resume procedure between a WTRU and a network;

FIG. 11 is a diagram illustrating a representative embodiment of a multi-hop relay communication procedure;

FIG. 12 is a diagram illustrating a representative embodiment of another multi-hop relay communication procedure;

FIG. 13 is a diagram illustrating a representative embodiment of another multi-hop relay communication procedure;

FIG. 14 is a diagram illustrating a representative embodiment of another multi-hop relay communication procedure;

FIG. 15 is a diagram illustrating a representative embodiment of another multi-hop relay communication procedure; and

FIG. 16 is a diagram illustrating a representative embodiment of another multi-hop relay communication procedure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

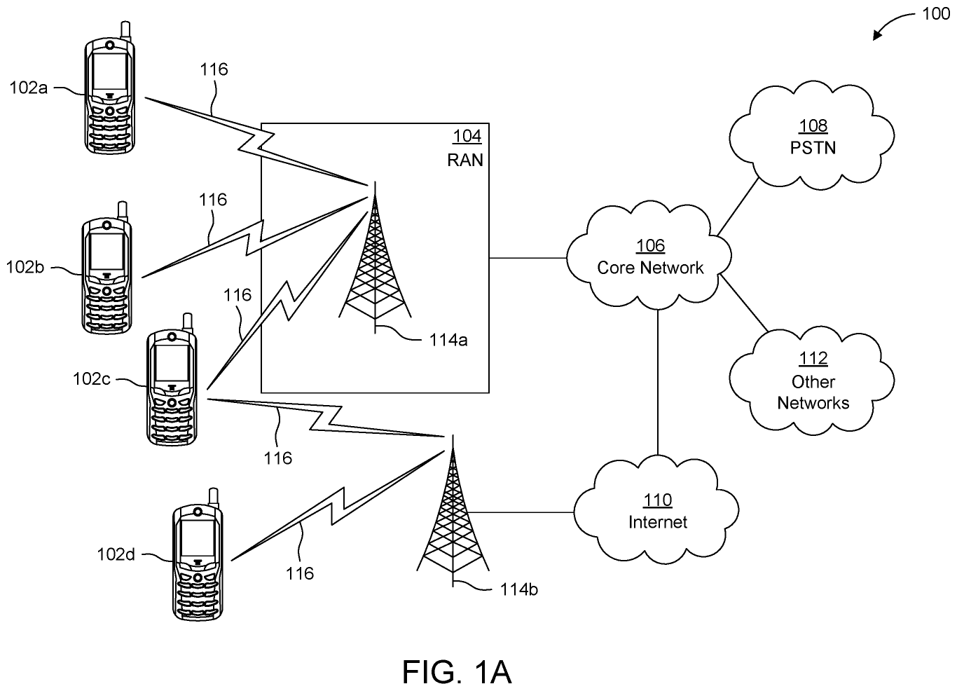

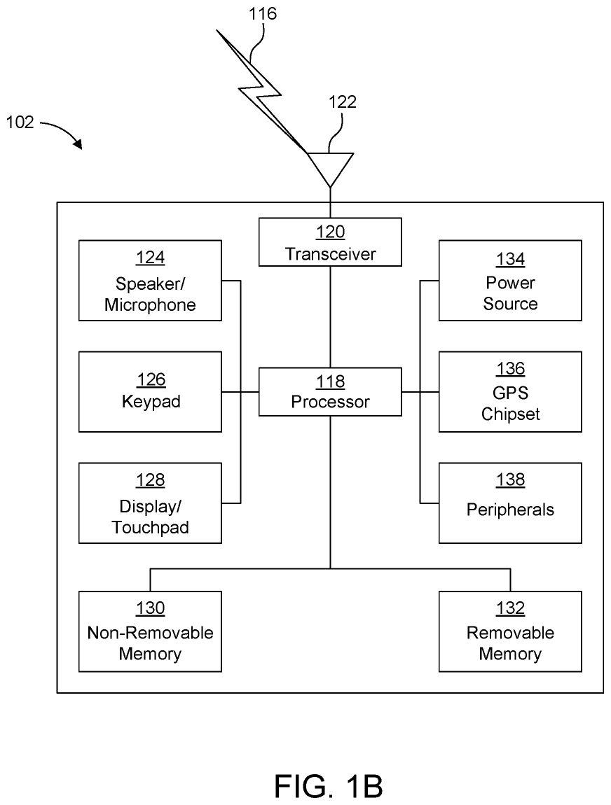

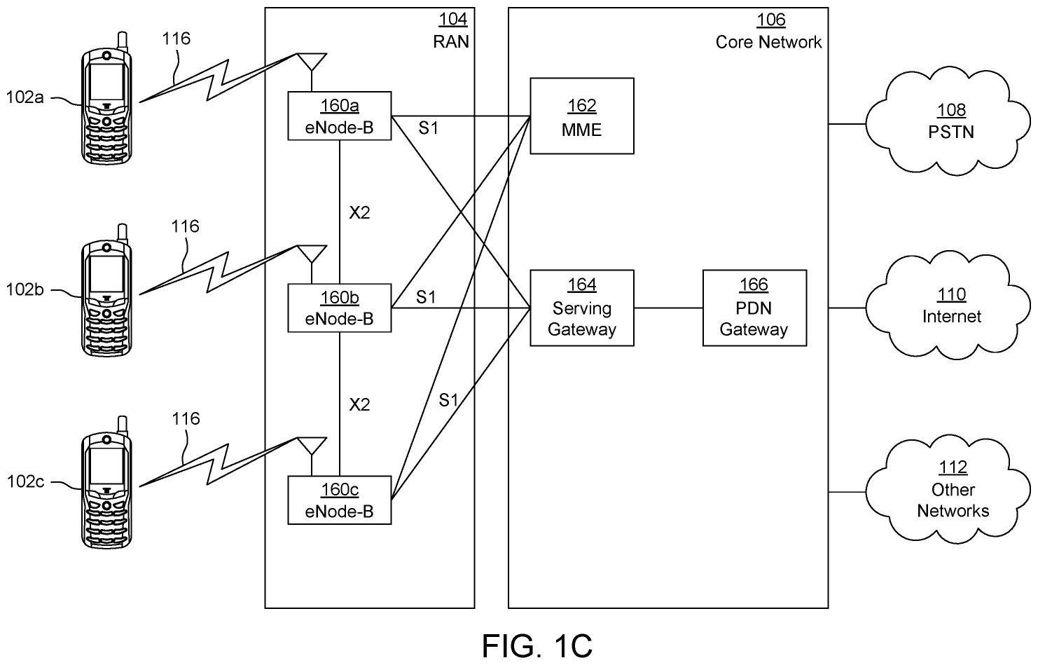

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an Si interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately.

The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11 af and 802.11 ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

For 3GPP Release 17, 3GPP will study the use of both (1) WTRU to network relays and (2) WTRU to WTRU relays based on PC5 (sidelink). In 3GPP Release 16, a first version of NR sidelink (SL) has been developed and is focused on supporting V2X-related road safety services. The design aims to provide support for broadcast, groupcast and unicast communications in both out-of-coverage and in-network coverage scenarios. SL-based relaying functionality should be additionally studied with an aim towards sidelink and/or network coverage extensions and power efficiency improvement, such as when considering a wider range of applications and services.

For example, coverage extensions for SL-based communications may include WTRU-to-network coverage extensions and/or WTRU-to-WTRU coverage extensions. Adequate network coverage (e.g., for Uu interface communication) is necessary for WTRUs to reach a server in a PDN network and/or counterpart WTRUs outside of the proximity of the coverage area. In 3GPP Release 13, WTRU-to-Network relays are limited to EUTRA-based technology and may not be applied to NR-based systems, such as for NG-RAN and/or NR-based SL communications. Currently, WTRU-to-WTRU proximity reachability is limited to single-hop SL links, either via EUTRA-based or NR-based SL technology. However, this may not be sufficient, such as in scenarios where there is no Uu coverage, considering the limitations of single-hop sidelink coverage. To support enhanced QoS requirements, it may be advantageous to extend SL connectivity within the NR framework.

In Release 17, the objectives may be to study single hop NR sidelink relays as follows: (1) study mechanism(s) with minimum specification impact to support the SA requirements for sidelink-based WTRU-to-network and WTRU-to-WTRU relays, focusing on the following aspects (if applicable) for layer-3 relays and layer-2 relays: relay (re-)selection criterion and procedure; relay/remote WTRU authorization; QoS for relaying functionality; service continuity; security of relayed connection after SA3 has provided its conclusions; and impact on user plane protocol stack and control plane procedure (e.g., connection management of relayed connection); and (2) study mechanism(s) to support upper layer operations of the discovery model and/or procedures for sidelink relaying, assuming no new physical layer channels and/or signals.

### WTRU-to-Network Relays

Relaying via proximity services (ProSe) WTRU-to-Network relays was introduced in Release 13 to extend network coverage to an out of coverage WTRU by using a PC5 interface (e.g., device-to-device) between the out of coverage WTRU and a WTRU-to-Network relay. A ProSe WTRU-to-Network Relay may provide a generic L3 forwarding function that can relay any type of IP traffic between the remote WTRU and the network. One-to-one and one-to-many sidelink communications may be used between the remote WTRU(s) and the ProSe WTRU-to-network relay. For both the remote WTRU and the relay WTRU only one single carrier (i.e., Public Safety ProSe Carrier) operation is supported (e.g., Uu and PC5 interfaces should be the same carrier for the relay and remote WTRUs). The remote WTRU may be authorized by upper layers and can be in-coverage of the Public Safety ProSe Carrier or out-of-coverage on any supported carriers including Public Safety ProSe Carrier for WTRU-to-network relay discovery, (re)selection and communication. The ProSe WTRU-to-network relay is always in-coverage of the EUTRAN. The ProSe WTRU-to-Network Relay and the Remote WTRU may perform sidelink communication and sidelink discovery as described in sections 23.10 and 23.11 of 3GPP TS 36.300.

### Relay Selection for WTRU-to-Network Relays

Relay selection and/or reselection for ProSe WTRU-to-network relays may be performed based on combination of a AS layer quality measurements (RSRP) and upper layer criteria. This is described in more detail in 3GPP TS 36.300 which states that the eNB controls whether the WTRU can act as a ProSe WTRU-to-Network Relay. If the eNB broadcasts any information associated to ProSe WTRU-to-Network Relay operation, then ProSe WTRU-to-Network Relay operation is supported in the cell. The eNB may provide: (1) transmission resources for ProSe WTRU-to-Network Relay discovery using broadcast signaling for RRC_IDLE state and dedicated signaling for RRC_CONNECTED state and (2) reception resources for ProSe WTRU-to-Network Relay discovery using broadcast signaling. The eNB may broadcasts a minimum and/or a maximum Uu link quality (RSRP) threshold(s) that the ProSe WTRU-to-Network Relay needs to respect before initiating a WTRU-to-Network Relay discovery procedure. In RRC_IDLE, when the eNB broadcasts transmission resource pools, the WTRU may use the threshold(s) to autonomously start or stop the WTRU-to-Network Relay discovery procedure. In RRC_CONNECTED, the WTRU uses the threshold(s) to determine if it can indicate to the eNB that it is a Relay WTRU and wants to start ProSe WTRU-to-Network Relay discovery. If the eNB does not broadcast transmission resource pools for ProSe-WTRU-to-Network Relay discovery, then a WTRU can initiate a request for ProSe-WTRU-to-Network Relay discovery resources by dedicated signaling, respecting these broadcasted threshold(s). If the ProSe-WTRU-to-Network Relay is initiated by broadcast signaling, it can perform ProSe WTRU-to-Network Relay discovery when in RRC_IDLE. If the ProSe WTRU-to-Network Relay is initiated by dedicated signaling, it can perform relay discovery as long as it is in RRC_CONNECTED.

A ProSe WTRU-to-Network Relay performing SL communication for ProSe WTRU-to-Network Relay operation has to be in RRC_CONNECTED. After receiving a layer-2 link establishment request or TMGI monitoring request (e.g., an upper layer message) from the Remote WTRU, the ProSe WTRU-to-Network Relay indicates to the eNB that it is a ProSe WTRU-to-Network Relay and intends to perform ProSe WTRU-to-Network Relay sidelink communication. The eNB may provide resources for ProSe WTRU-to-Network Relay communication.

The remote WTRU can decide when to start monitoring for ProSe WTRU-to-Network Relay discovery. The remote WTRU can transmit ProSe WTRU-to-Network Relay discovery solicitation messages while in RRC_IDLE or in RRC_CONNECTED depending on the configuration of resources for ProSe WTRU-to-Network Relay discovery. The eNB may broadcast a threshold, which is used by the remote WTRU to determine if it can transmit ProSe WTRU-to-Network Relay discovery solicitation messages, to connect or communicate with the ProSe WTRU-to-Network Relay WTRU. The RRC_CONNECTED remote WTRU, uses the broadcasted threshold to determine if it can indicate to the eNB that it is a remote WTRU and wants to participate in ProSe WTRU-to-Network Relay discovery and/or communication. The eNB may provide, transmission resources using broadcast or dedicated signaling and reception resources using broadcast signaling for ProSe WTRU-to-Network Relay Operation. The remote WTRU stops using ProSe WTRU-to-Network Relay discovery and communication resources when RSRP goes above the broadcasted threshold. Timing of traffic switching from Uu to PC5 or vice versa is up to higher layers.

The remote WTRU performs radio measurements at the PC5 interface and uses them for ProSe WTRU-to-Network Relay selection and reselection along with higher layer criterion. A ProSe WTRU-to-Network Relay is considered suitable in terms of radio criteria if the PC5 link quality exceeds a configured threshold (e.g., pre-configured or provided by eNB). The remote WTRU selects the ProSe WTRU-to-Network Relay which satisfies higher layer criterion and has a best PC5 link quality among all suitable ProSe WTRU-to-Network Relays.

The Remote WTRU may trigger ProSe WTRU-to-Network Relay reselection when the

PC5 signal strength of the current ProSe WTRU-to-Network Relay is below the configured signal strength threshold, and/or it receives a layer-2 link release message (e.g., an upper layer message) from the ProSe WTRU-to-Network Relay.

### WTRU-to-Network Relays for Wearables

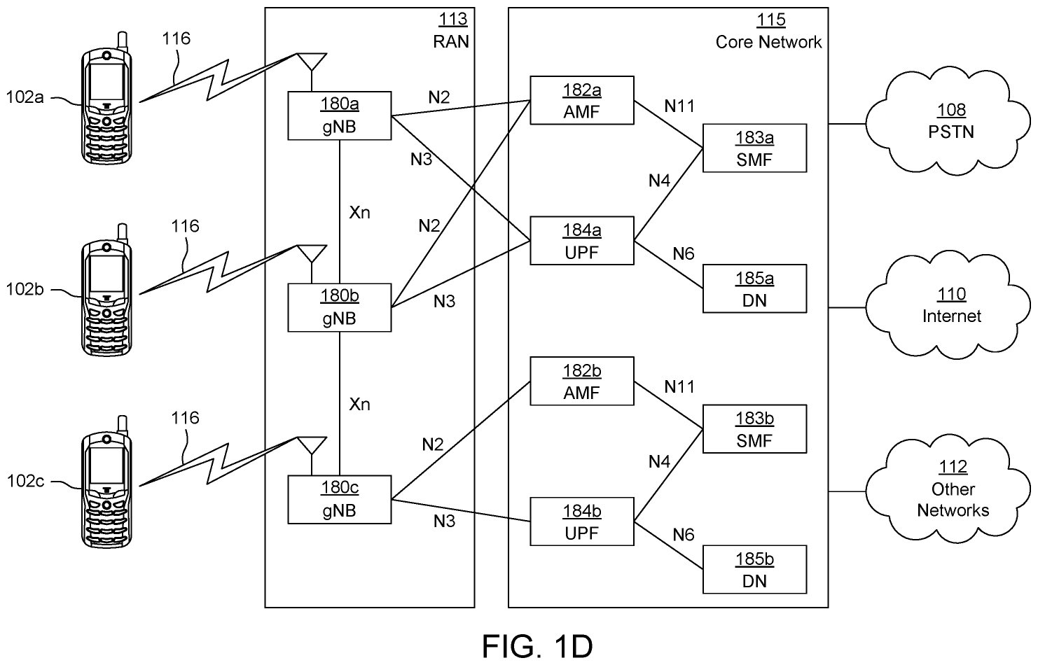

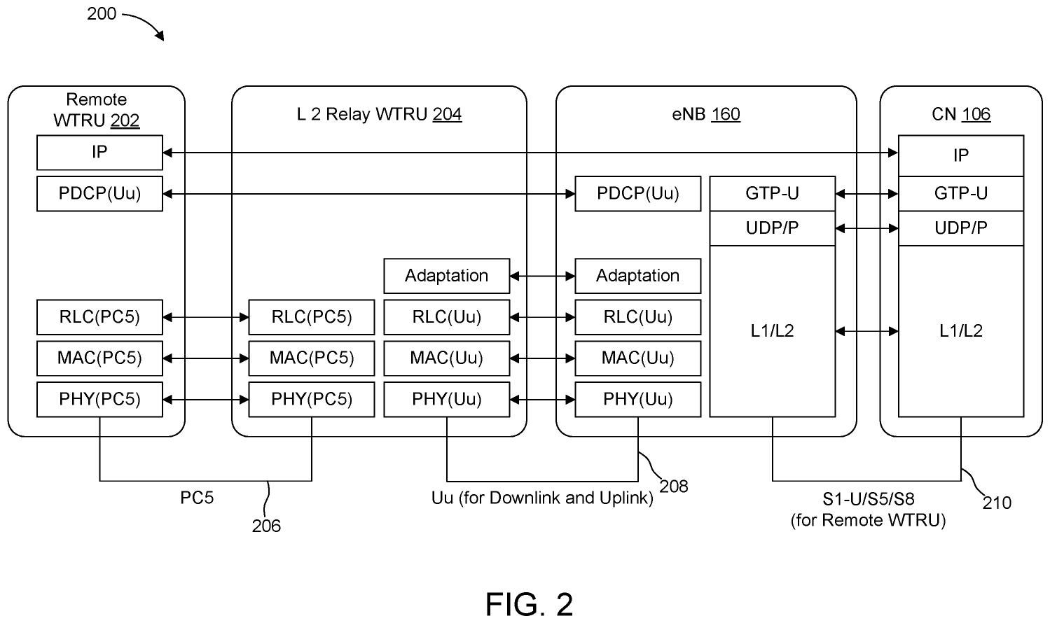

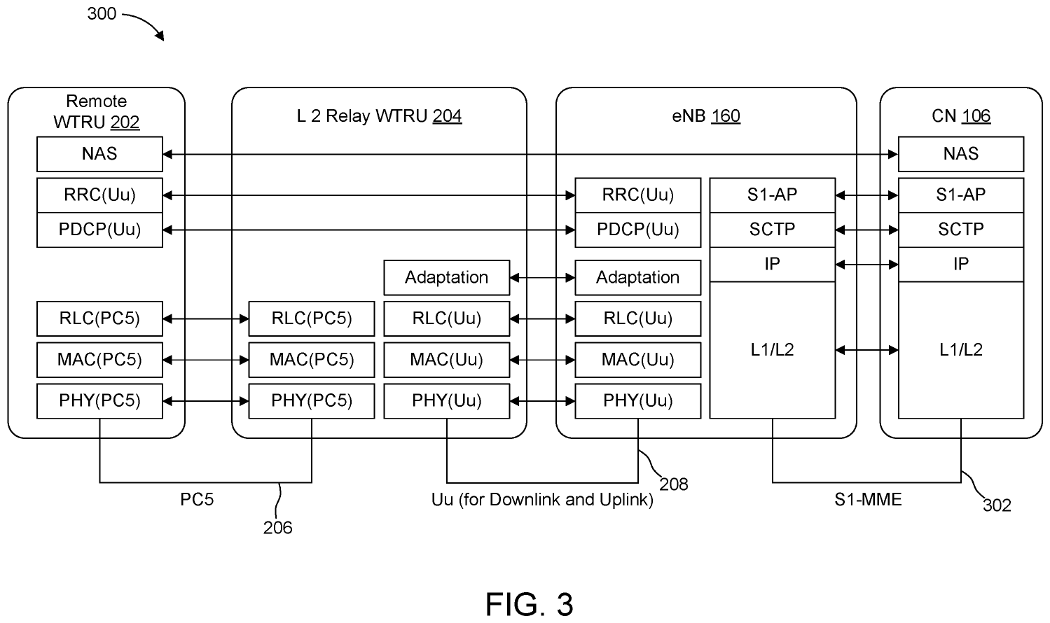

In Release 14, a study for WTRU-to-NW relays for commercial use cases tailored to wearables and IoT devices was performed by 3GPP. While the study did not result in any specification, a technical report (TR) provided a number of solutions for such relays. Compared to ProSe WTRU-to-NW relays which use a L3 (e.g., IP layer) relaying approach, WTRU-to-Network relays for wearables may use a L2 relaying approach based on the protocol stacks shown in FIGS. 2 and 3.

FIG. 2 is a diagram illustrating a system 200 overview for a user plane radio protocol stack for a L2 evolved WTRU-to-Network relay using a PC5 interface. A remote WTRU 202 may communicate with a L2 relay WTRU 204 via a PC5 interface 206. A S1-U/SS/S8 interface 210 between the eNB and a CN is used for communications with remote the remote WTRU 202. A Uu interface 208 between the L2 Relay WTRU 204 and the eNB 160 is used for downlink and uplink communications. The PC5 interface 206 between the remote WTRU 202 and the L2 Relay WTRU 204 is used for the remote WTRU 202 to communicate with the eNB 160 and/or CN 106.

FIG. 3 is a diagram illustrating a system 300 overview for a control plane radio protocol stack for a L2 evolved WTRU-to-Network relay using a PC5 interface. A remote WTRU 202 may communicate with a L2 relay WTRU 204 via a PC5 interface 206. A S1-MME interface 302 between the eNB 160 and a CN 106 is used for communications between the eNB 160 and the CN 106. A Uu interface 208 between the L2 Relay WTRU 204 and the eNB 160 is used for downlink and uplink communications. The PC5 interface 206 between the remote WTRU 202 and the L2 Relay WTRU 204 is used for the remote WTRU 202 to communicate with the eNB 160 and/or CN 106.

### Connection Establishment for Unicast Links in NR V2X

Relay solutions in previous releases of the LTE specification were based on a one to one communication link established at upper layers (e.g., a ProSe layer) between two WTRUs (e.g., the remote WTRU and the WTRU-to-NW relay). Such a connection was transparent to the AS layer and connection management signaling and procedures performed at the upper layers are carried by AS layer data channels. The AS layer may be considered to be unaware of such a one to one connection.

In Release 16 for NR V2X, the AS layer supports a unicast link between two WTRUs. The unicast link may be initiated by upper layers (e.g., as in the ProSe one-to-one connection). However, the AS layer is informed of the presence of the unicast link and any data that is transmitted in unicast fashion between the peer WTRUs. With such knowledge, the AS layer may support HARQ feedback, CQI feedback, and/or power control schemes which are specific to unicast. At the AS layer, the unicast link may be supported via a PC5-RRC connection. In Release 16, TS 38.331 defines the PC5-RRC connection as follows:
“NR sidelink communication consists of unicast, groupcast and broadcast. For unicast, the PC5-RRC connection is a logical connection between a pair of a Source Layer-2 ID and a Destination Layer-2 ID in the AS. The PC5-RRC signaling, as specified in sub-clause 5.8.9, can be initiated after its corresponding PC5 unicast link establishment (TS 23.287 [55]). The PC5-RRC connection and the corresponding sidelink SRBs and sidelink DRB(s) are released when the PC5 unicast link is released as indicated by upper layers.
For each PC5-RRC connection of unicast, one sidelink SRB (i.e., SL-SRB0) is used to transmit the PC5-S message(s) before the PC5-S security has been established. One sidelink SRB (i.e., SL-SRB1) is used to transmit the PC5-S messages to establish the PC5-S security. One sidelink SRB (i.e., SL-SRB2) is used to transmit the PC5-S messages after the PC5-S security has been established, which is protected. One sidelink SRB (i.e., SL-SRB3) is used to transmit the PC5-RRC signaling, which is protected and only sent after the PC5-S security has been established.”

For example, the PC5-RRC signaling may include a sidelink configuration message (e.g., RRCReconfigurationSidelink) where one WTRU configures the RX-related parameters of each SL radio bearer (RB) in the peer WTRU. The reconfiguration message may configure the parameters of each protocol layer in the L2 stack (e.g., SDAP, PDCP, etc.). The receiving WTRU may confirm or reject the configuration, such as depending on whether the receiving WTRU can support the configuration suggested by the peer WTRU.

### Connection Management for Single Hop WTRU-to-NW Relays

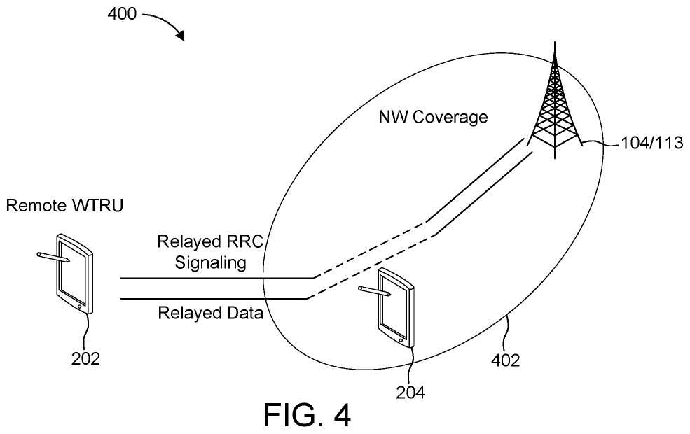

FIG. 4 is a system diagram illustrating a single hop relay example 400. In FIG. 4, a remote WTRU 202 connected to a WTRU-to-NW relay 204 may have a RRC state with respect to the network, and signaling transmissions for RRC state transition may be relayed by the relay WTRU 204. Once in an RRC_CONNECTED state (e.g., after an RRC connection establishment or RRC connection resume procedure), a remote WTRU may communicate with the network using legacy RRC signaling that is relayed via the WTRU-to-NW relay. In FIG. 4, relayed data and relayed RRC signaling from a remote WTRU 202 are communicated by a WTRU-to-NW relay 204 to a RAN 104/113. In FIG. 4, the remote WTRU 202 is outside of the network coverage 402 provided by the RAN 104/113.

For example, the following RRC state combinations for the remote WTRU 202 and the relay WTRU 204 may be supported as shown in Table 1 below:

TABLE 1

| Remote WTRU | Relay WTRU |
|---|---|
| RRC_IDLE | RRC_IDLE or |
| | RRC_INACTIVE or |
| | RRC_CONNECTED |
| RRC_INACTIVE | RRC_IDLE or |
| | RRC_INACTIVE or |
| | RRC_CONNECTED |
| RRC_CONNECTED | RRC_CONNECTED |

As shown in Table 1, a remote WTRU 202 in RRC_CONNECTED requires that its attached relay WTRU 204 also be in RRC_CONNECTED. When a remote WTRU 202 in RRC_IDLE and/or RRC_INACTIVE initiates a connection establishment and/or resume procedure, the remote WTRU 202 transmits the first RRC message (e.g., via SRB0) to the relay WTRU 204 using a default SL RLC channel. This allows a relay WTRU 204 in RRC_IDLE and/or RRC_INACTIVE to transparently initiate its own RRC connection establishment (e.g., so as to achieve the allowable RRC_CONNECTED state combination for the remote and the relay WTRUs 202 and 204).

### Overview

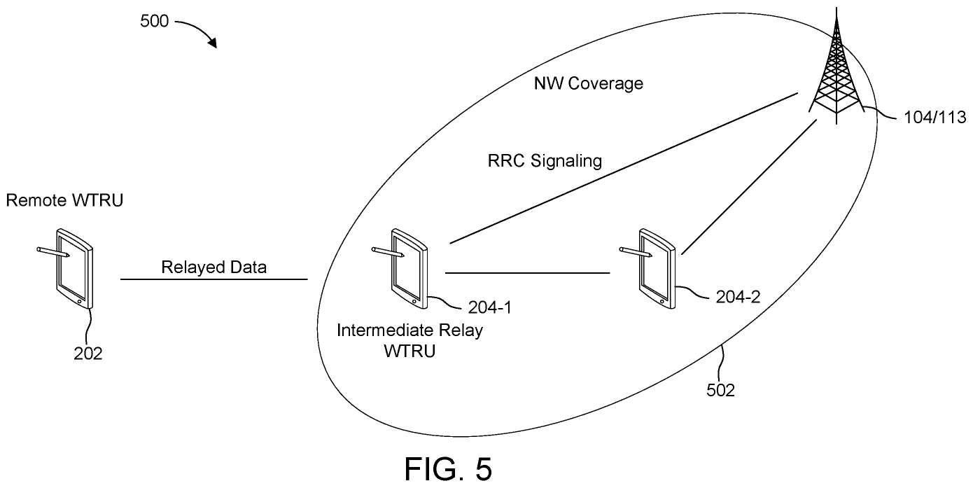

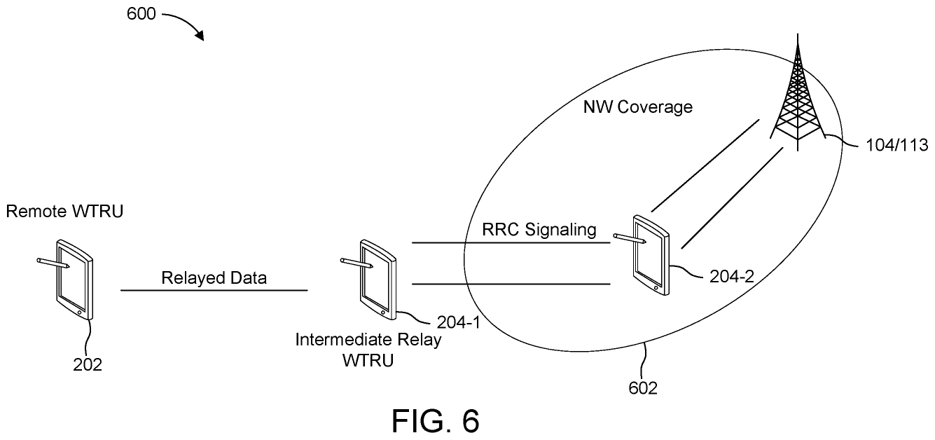

FIG. 5 is a system diagram illustrating a multi-hop relay example 500. FIG. 6 is a system diagram illustrating a multi-hop relay example 600. In FIGS. 5 and 6, multi-hop WTRU to NW relaying may further enhance network coverage by using multiple (e.g., an integer ‘n’ greater than or equal to 2) relay WTRUs 204-n (e.g., 204-1, 204-2, . . . , 204-n) in a successive chain of relaying for a remote WTRU 202. For each relay WTRU 204-n in the chain (e.g., apart from the last relay connected to the gNB), the relay WTRU 204-n may receive incoming data on a sidelink (SL) and relay the received data via a sidelink. For example, a context in the network (e.g., the WTRU in RRC_CONNECTED or RRC_INACTIVE) for such a relay WTRU 204-n may not be required. In view of this (e.g., unlike for single hop, or for the last relay in multi-hop), automatically initiating a connection establishment procedure upon connection establishment of the remote WTRU 202 is not necessary. Any relay WTRU 204-n could remain in RRC_INACTIVE and/or RRC_IDLE, and still relay traffic for the remote WTRU 202 via sidelink (e.g., using mode 2 resource allocation and resource pools which are preconfigured—WTRU SL resource selection). In some cases, it may be advantageous to avoid having to perform other procedures at the relay WTRU 204-n which are associated with RRC_CONNECTED (e.g., measurements and measurement reporting).

In some cases, it may be advantageous to have the relay WTRUs 204-n in RRC_CONNECTED as it may result in more efficient sidelink resource usage (e.g., either via a relayed version of mode 1, where the network manages the SL resources, or having the network alter the resource pool configurations). In some cases, it may be advantageous for the NW to have more control over the relaying, such as where an RRC_CONNECTED WTRU may be configured with a dedicated adaptation layer configuration that is specific to a QoS of its remote WTRUs 202.

In certain representative embodiments, a relay WTRU 204-n (e.g., in IDLE and/or INACTIVE) may perform procedures to determine whether to initiate its own connection establishment when a remote WTRU 202 requests a connection establishment.

In certain representative embodiments, a relay WTRU 204-n (e.g., in IDLE and/or INACTIVE) may perform procedures to determine one or more timers (e.g., time durations) which are associated with connection establishment (e.g., at an intermediate relay).

In certain representative embodiments, a relay WTRU 204-n (e.g., in IDLE and/or INACTIVE) may perform procedures for connection establishment which address variable latencies associated with multi-hop links.

In certain representative embodiments, a SL relay WTRU 204-n may determine whether to perform a connection establishment (e.g., with a RAN 104/113). For example, a connection establishment timer and/or an adaptation layer configuration may be based on any of a cumulative weight value (e.g., broadcast by another WTRU), a measured CBR, and/or a QoS of data to be relayed.

In certain representative embodiments, a relay WTRU 204-n may implement a procedure which includes receiving a cumulative weight value from another relay WTRU 204-n (e.g., a parent WTRU) which represents a number of hops along a path to a gNB 180 and a respective RRC state of a relay WTRU 204-n associated with each hop along the path. The procedure may also include measuring a CBR, and receiving a connection establishment request (e.g., for a Uu connection) from a remote WTRU 202 in RRC_INACTIVE (e.g., a child WTRU). The procedure may further include determining a QoS from a SL RLC channel configuration from the remote WTRU 202.

For example, on condition that the measured CBR is above a threshold (e.g., a configured threshold based on QoS and/or cumulative weight), the relay WTRU 204-n may (1) set a connection establishment timer (e.g., timer T300) to a configured value corresponding to the cumulative weight value, (2) initiate a connection establishment procedure (e.g., for a Uu RRC connection) after reception of the connection establishment request, and start the connection establishment timer (e.g., to count down to zero), and/or perform relaying of a SL RLC channel (or any subsequent SL RLC channels) using a NW configured mapping.

For example, on condition that the measured CBR is not above a threshold, the relay WTRU 204-n may perform relaying of a SL RLC channel while remaining in IDLE using a default adaptation layer configuration. The default adaptation layer configuration may include one or more default egress SL RLC channel configurations and a mapping of an ingress priority to one of the egress SL RLC channel configurations.

### Connection Establishment in Multi-Hop WTRU to NW Relays

### RRC Connection for an Intermediate WTRU-to-NW Relay

In certain representative embodiments, a WTRU 102 acting as an intermediate relay WTRU 204-n in a multi-hop WTRU to NW relay link may itself be associated with a Uu RRC state.

In certain representative embodiments, the relay WTRU 204-n may be in network coverage and may have a RRC connection via a Uu interface to the RAN (e.g., gNB). In FIG. 5, any relay WTRU 204-1 or 204-2 may be in the RRC_CONNECTED, RRC_IDLE, or RRC_INACTIVE state. As shown in FIG. 5, a plurality of WTRUs 102 may be located in an area of the network coverage 502 of a RAN 104/113 (e.g., gNB 180). A remote WTRU 202 may be located outside of the network coverage 502. A relay WTRU 204-n (e.g., an intermediate relay WTRU 204-1) may further be configured to perform multi-hop WTRU-to-NW relaying for a remote WTRU 202 (e.g., via a relayed path), in any of the RRC_CONNECTED, RRC_IDLE, and/or RRC_INACTIVE states. For example, the relay WTRU 204-n may be in RRC_INACTIVE, but may serve a (e.g., active) remote WTRU 202 that is in RRC_CONNECTED, where a sidelink between the RRC_INACTIVE relay WTRU 204-1 and another relay WTRU 204-2 may be used for relaying the remote WTRU communications (e.g., without the need for the intermediate relay 204-1 to be in RRC_CONNECTED).

In certain other representative embodiments, a relay WTRU 202 may be outside of coverage and may have a RRC connection via another relay WTRU 204-n to the RAN 104/113 (e.g., gNB 180). FIG. 6 is a system diagram illustrating another multi-hop relay example 600. In FIG. 6, any relay WTRU 204-n may be in the RRC_CONNECTED, RRC_IDLE, and/or RRC_INACTIVE states. As shown in FIG. 6, one or more WTRUs 204-n may be located in an area of network coverage 602 of a RAN 104/113 (e.g., gNB 180) and one or more WTRUs 204-n may be located outside of the network coverage area of a RAN (e.g., gNB). A remote WTRU 202 may be located outside of the network coverage area. For a relay WTRU 204-1 outside of the network coverage, the relay WTRU 202 may have an RRC state with respect to the Uu, interface where the signaling and/or maintenance of the RRC state (e.g., of the outside-of-coverage relay WTRU 204-1) is via the relayed path (e.g., entirely via the relayed path). The relay WTRU 204-1 may be configured to perform multi-hop WTRU-to-NW relaying for the remote WTRU 202 (e.g., via a relayed path), in any of the RRC_CONNECTED, RRC_IDLE, and/or RRC_INACTIVE states. For example, the relay WTRU 204-1 may be in RRC_INACTIVE, and may serve an active remote WTRU 202 that is in RRC_CONNECTED, where a sidelink between the RRC_INACTIVE relay WTRU 204-1 and another relay WTRU 204-2 may be used for relaying the remote WTRU communications (e.g., without the need for the intermediate relay WTRU 204-1 to be in RRC_CONNECTED).

As shown in FIG. 5, the path which the RRC signaling takes may use the Uu interface. As shown in FIG. 6, the path which the RRC signaling takes may use a sidelink connection to another WTRU relay 204-2 (e.g., in the network coverage 602). In FIG. 5, the relay WTRU 204-1 may be scheduled (e.g., via the Uu interface) for sidelink transmissions using mode 1 (e.g., network scheduled) SL scheduling mode.

In certain other representative embodiments, the RRC signaling (e.g., RRC connection) for an intermediate relay WTRU 204-1 may be relayed to the RAN (e.g., gNB) either using the direct path (e.g., via the Uu interface) and/or the indirect path (e.g., via sidelink).

While FIGS. 5 and 6 illustrate a WTRU-to-network relay 204-n (e.g., where the source and/or destination is a network node), those of skill in the art should understand that in other representative embodiments, the WTRU-to-network relay 204-2 may be replaced by a WTRU-to-WTRU relay (e.g., where the source and/or destination is another WTRU).

While FIGS. 5 and 6 illustrate a WTRU-to-network relay 204-n (e.g., where the source and/or destination is a network node), those of skill in the art should understand that in other representative embodiments, there may be one or more intermediate relay WTRUs 204-1 and/or one or more remote WTRUs 202 located outside of the network coverage. As described herein, an RRC connection and/or an RRC state associated with an intermediate relay WTRU 204-n as described herein may refer to any of the RRC_CONNECTED, RRC_IDLE, and/or RRC_INACTIVE states.

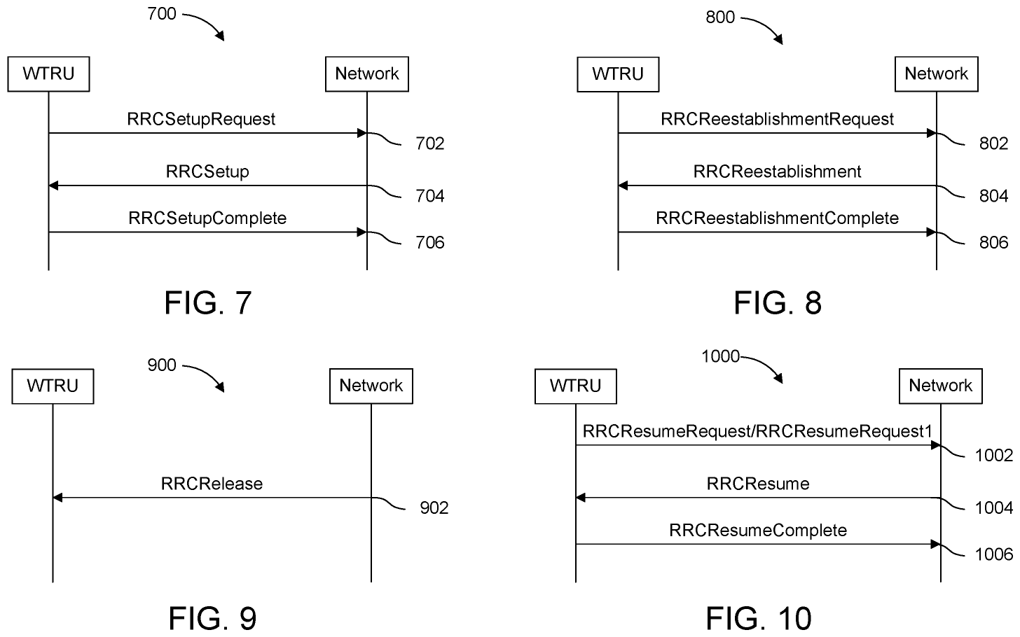

FIG. 7 is a diagram illustrating a RRC establishment procedure 700 between a WTRU 102 (e.g., in network coverage) and a network (e.g., gNB) that may be performed to setup a WTRU 102 in the RRC_CONNECTED state. At 702, the WTRU 102 may send a RRCSetupRequest message to the network at 702. At 704, the WTRU 102 may receive a RRCSetup message from the network. At 706, the WTRU 102 may send a RRCSetupComplete message to the network.

FIG. 8 is a diagram illustrating a RRC re-establishment procedure 800 between a WTRU 102 (e.g., in network coverage) and a network (e.g., gNB 180) that may be performed to re-establish a WTRU 102 in RRC_CONNECTED. At 802, the WTRU 102 may send a RRCReestablishmentRequest message to the network. At 804, the WTRU 102 may receive a RRCReestablishment message from the network. At 806, the WTRU 102 may send a RRCReestablishmentComplete message to the network.

FIG. 9 is a diagram illustrating a RRC release procedure 900 between a WTRU 102 (e.g., in network coverage) and a network (e.g., gNB 180) that may be performed to transit a WTRU 102 in RRC_CONNECTED to RRC_INACTIVE or RRC_IDLE. At 902, the WTRU 102 may send a RRCRelease message to the network.

FIG. 10 is a diagram illustrating a RRC resume procedure 1000 between a WTRU 102 (e.g., in network coverage) and a network (e.g., gNB 180) that may be performed to transit a WTRU 102 in RRC_INACTIVE to RRC_CONNECTED. At 1002, the WTRU 102 may send a RRCResumeRequest or a RRCResumeRequest1 message to the network. At 1004, the WTRU 102 may receive a RRCResume message from the network. At 1006, the WTRU 102 may send a RRCResumeComplete message to the network.

In FIGS. 7-10, the RRC procedures may be modified so that the WTRU 102 receives a failure or reject message from the network, such as when transitioning to RRC_CONNECTED fails. Similar procedures may be performed by a remote WTRU 202 and/or an intermediate relay WTRU 204-1 and another relay WTRU 204-n, such as when the remote WTRU 202 and/or the intermediate relay WTRU 204-1 are outside of network coverage.

As described herein, the term “parent relay” may refer to a relay WTRU 204-n that is serving another relay WTRU (e.g., a “child relay”), such as relay WTRU 204-1, for sending data in the upstream direction and receiving data in the downstream direction, such as for the case of WTRU-to-Network relaying. In cases of WTRU-to-WTRU relaying, the terms upstream and downstream are interchangeable, depending on the direction of flow from one WTRU 102 to another WTRU 102, and as such, so are the terms parent and child relay.

As described herein, the term “intermediate relay” may be used to describe a relay WTRU 204-n that is serving a remote WTRU 202 and/or another relay WTRU 202-1, and is also being served by another relay WTRU 204-n.

As described herein, the term “final relay” WTRU may be used to describe a relay WTRU 204-2 that is being served directly (e.g., by the Uu interface) by a gNB 180 and/or acting as a last hop to a destination node.

### Connection Establishment Procedure

In certain representative embodiments, a remote WTRU 202 and/or a relay WTRU 204-1 may initiate connection establishment and/or resume procedures by a transmission of a first RRC message via a relay WTRU 204-2, which may be referred to herein as an “SRB0” message. This first RRC message may be a Uu RRC message (e.g., RRCSetupRequest, RRCResumeRequest, RRCReestablishmentRequest, etc.) transmitted on a default (or specified) SL RLC channel which may be dedicated for transmission thereof, such as when a connection establishment procedure is performed via a SL relay. A remote WTRU 202 may use a same or different default (or specified) SL RLC channel for transmission of the RRC message initiated following a network controlled mobility, such as a RRCReconfigurationComplete message following a HO to a relay WTRU 204-n (e.g., indicated by the network via an RRC message). For example, the first message transmitted to the relay WTRU 204-1 to which a remote WTRU 202 has a unicast link may be transmitted on a default (or specified) RLC channel.

### Default SL RLC Channel for Multi-Hop Relaying

In certain representative embodiments, a relay WTRU 204-n may create a default and/or specified RLC channel towards another relay node in the upstream for multi-hop relaying via sidelink. The default and/or specified RLC channel may be associated with transmission of the first RRC message received via a default SL RLC channel. The default and/or specified RLC channel may also associated with a first Uu RRC message.

A relay WTRU 204-n may create (e.g., configure) a different default and/or specified RLC channel for transmission of SRB0 which is received, or to be received, from another WTRU 204-n as compared with the default and/or specified RLC channel used for its own transmission of SRB0. For example, the relay WTRU 204-n may create a default SL RLC channel for reception of SRB0 messages from a remote WTRU 202 or another child relay WTRU 204-n. The relay WTRU 204-n may create a SL RLC channel, which is linked to the reception RLC channel, for further transmission of the received SRB0 data. Upon reception of a message on the default and/or specified RLC channel for reception, the relay WTRU 204-n may forward the received message to the default and/or specified RLC channel for transmission. Such forwarding may be accompanied by triggering connection establishment at the relay WTRU 204-n itself (e.g., if the relay WTRU 204-n was in RRC_INACTIVE and/or RRC_IDLE). Conditions under which a relay WTRU 204-n, upon reception of a SRB0 message from another WTRU 202/204-n may (or may not) trigger a connection establishment procedure on the Uu interface are described herein, such as when the relay WTRU 204-n is not already in RRC_CONNECTED.

A relay WTRU 204-n may use a same default and/or specified RLC channel for relaying the SRB0 message from a remote WTRU 202 as well as its own SRB0 message(s). The relay WTRU 204-n may indicate the presence of a forwarded message, such as in the SRB0 message itself. The relay WTRU may also behave differently with respect to the initiation of a connection establishment. For example, a forwarded message may initiate a connection establishment procedure and a message generated by the WTRU 204-n itself may not initiate a connection establishment procedure.

A relay WTRU 204-n may be configured with a default and/or specified SL RLC channel for reception of a Uu response message (e.g., a SRB1 message). A relay WTRU 204-n configured as a multi-hop relay may be configured with two default and/or specified SL RLC channels. For example, upon reception over a first channel, the relay WTRU 204-n may consider the message destined for itself and forward the message to upper layers (e.g., RRC). Upon reception over a second channel, the relay WTRU 204-n may forward the message to a next hop remote WTRU 204-n. As another example, the message may be received over a same sidelink RLC channel and the relay WTRU 204-n may determine whether to forward the message to upper layers or to forward to a next hop remote WTRU, such as based on an identity included with the message.

### Changing Default/Specified RLC Channel Configuration Upon Cell/Relay Reselection

In certain representative embodiments, a WTRU 204-n may perform cell and/or relay reselection while it (e.g., the WTRU 204-n) is actively serving as an intermediate or final WTRU 204-n for a WTRU or another WTRU 204-n. The WTRU 204-n may change the configuration of any of the default and/or specified SL RLC channels upon cell and/or relay reselection. Specifically, the WTRU 204-n may perform any of the following: (1) release a SL RLC bearer, (2) create a SL RLC bearer, and/or (3) update a SL RLC bearer.

For example, a WTRU 204-n may release any of a default and/or a specified SL RLC bearer for transmission, such as upon reselection from a WTRU 204-n (e.g., a next hop) to direct Uu (e.g., a cell). On condition the WTRU 204-n performs cell and/or relay reselection and moves from being served by a WTRU 204-n to a gNB cell, the WTRU 204-n may release a default and/or specified SL RLC channel for transmission.

For example, a WTRU 204-n may create any of a default and/or a specified SL RLC channel for transmission upon reselection, such as from a WTRU 204-n (e.g., a next hop) to a cell (e.g., direct Uu).

For example, a WTRU 204-n may change from routing a default and/or a specified SL RLC bearer (e.g., for reception of SRB0) from a (e.g., default/specified) SL RLC bearer to a Uu RLC bearer (e.g., SRB0/1 on Uu) or vice versa, such as when the WTRU 204-n reselects from a relay to a gNB cell or vice versa, respectively

### Multi-Hop Relay in IDLE/INACTIVE Determines Whether to Initiate a Connection Establishment Procedure Upon Reception of a Trigger for Connection Establishment of the Remote WTRU

A WTRU 204-n which is serving as a multi-hop relay may determine whether to initiate its own Uu RRC connection establishment procedure upon a trigger. For example, the trigger may be reception of a message on a default and/or specified (e.g., SRB0) SL RLC channel. Another trigger may be any of reception of a PC5-RRC message, reception of a Uu RRC message, reception of a paging message, etc. A connection establishment procedure as described herein may include other procedures initiated by the WTRU, such as a connection establishment procedure, a connection resume procedure, small data transmission procedure, RAN area update procedure, etc. The WTRU 204-n may perform such determination based on any of a set of conditions, a first condition determining whether or not to check other second conditions, and/or a first condition determining how (e.g., selecting thresholds) to check other second conditions. In certain representative embodiments, the conditions may include any of hop count, a configured value of some equivalent identifier (possibly associated with the SRB0 itself), or knowledge of such based on an interface of the next hop for that SRB0, an RRC state, a network configured behavior or preference, SL measurements, SL RLC channels associated with the remote WTRU, coverage and/or Uu measurements, a Uu bearer configuration, RRC states of any remote WTRUs, RRC states of any parent relay WTRUs 204-n, an indication from a remote WTRU, and/or a number of remote WTRUs being served (e.g., single hop and/or multi-hop).

A hop count, the configured value of some equivalent identifier (possibly associated with the SRB0 itself), or the knowledge thereof (e.g., based on interface of the next hop for that SRB0) may be one of the conditions described above. A WTRU 204-n may be configured with a hop count, as described herein. A WTRU 204-n may further be configured with a condition on the hop count (e.g., a hop count less than x). If the condition is met or exceeded, the WTRU 204-n may initiate a connection establishment. Otherwise, the WTRU 204-n may not initiate such procedure. As another example, a WTRU 204-n for which the SRB0 has a next hop corresponding to the Uu interface, may initiate a connection establishment, whereas a WTRU 204-n for which the SRB0 has a next hop that is relayed on SL may not initiate a connection establishment, or may use another condition herein.

For example, the hop count may be specific to an RLC channel, such as the RLC associated with SRB0. A WTRU 204-n may serve both as a WTRU-to-WTRU relay or a multi-hop relay (e.g., for some remote WTRUs) and a WTRU-to-NW relay (e.g., for some other remote WTRUs). For some remote WTRUs, a WTRU 204-n may have an RLC channel for SRB0 corresponding to a last hop to the gNB (e.g., it is the relay which is connected to the gNB), while for other remote WTRUs, the WTRU 204-n may have an RLC channel for SRB0 which does not correspond to a last hop to the gNB in the UL (e.g., it is indirectly connected to the gNB). In such case, the determination of whether the WTRU triggers an access procedure upon reception from a RLC channel for SRB0 may depend on whether the message is received from the first type of RLC channel or the second type of RLC channel.

A RRC state (e.g., IDLE, INACTIVE, and/or CONNECTED) on Uu may be one of the conditions described above. For example, a WTRU 204-n may initiate a connection establishment procedure when in RRC_IDLE. For example, a WTRU 204-n may not initiate a connection establishment procedure when in RRC_INACTIVE or RRC_CONNECTED. For example, a WTRU 204-n in RRC_INACTIVE may maintain an adaptation layer configuration (e.g., a mapping from ingress to egress) configured by the network in RRC_INACTIVE. For example, a WTRU 204-n in RRC_IDLE may release its adaptation layer configuration when moving to RRC_CONNECTED.

A network configured behavior and/or preference may be one of the conditions described above. For example, a WTRU may be configured (e.g., by the network in SIB and/or dedicated RRC signaling) whether to initiate a connection establishment procedure upon reception of a message which includes information indicating a specific configuration parameter. For example, a WTRU with an adaptation layer configuration (e.g., a mapping of ingress to egress bearers at the adaptation layer) may not initiate a connection establishment procedure. For example, a WTRU without an adaptation layer configuration may initiate a connection establishment procedure. As another example, a WTRU with an adaptation layer configuration may initiate a connection establishment procedure. For example, a WTRU without an adaptation layer may not initiate a connection establishment procedure.

For example, a WTRU without a configuration for mapping an ingress SL RLC channel, such as a SL RLC channel associated with a specific remote WTRU 202, may initiate an RRC connection establishment procedure. For example, a WTRU with a configuration for mapping an ingress SL RLC channel may not an RRC connection establishment procedure. A WTRU 204-n may be configured with one or more triggers for releasing an adaptation layer configuration, such as: (1) the WTRU 204-n reselects to a different cell and/or relay (or to a different relay connected to a different cell), (2) the WTRU 204-n reselects to a different RAN area or a similar configured area (e.g., a specified group of cells), or to a different relay connected to a different RAN area or similar configured area; and/or (3) the WTRU 204-n changes its RRC state (e.g., transitions from RRC_CONNECTED to RRC_IDLE, or transitions from RRC_CONNECTED to RRC_INACTIVE).

One or more SL measurements (e.g., CBR) may be one of the conditions described above. For example, a WTRU 204-n may be configured with a condition on a measured CBR (e.g., the CBR is above a threshold). If the SL measurements satisfy a condition, the WTRU 204-n may initiate a connection establishment procedure upon reception of a message from a remote WTRU 202 on SRB0. If the one or more SL measurements do not satisfy the condition, the WTRU 204-n may not initiate a connection establishment procedure upon reception of a message from a remote WTRU 202 on SRB0.

One or more SL RLC channels associated with a remote WTRU 202 may be one of the conditions described above. For example, a WTRU 204-n may be configured with a condition associated with a configuration property of the SL RLC channels with the remote WTRU 202, which may determine whether to perform connection establishment and/or resume, or remain in RRC_IDLE and/or RRC_INACTIVE. This may be reflective of the QoS of the data relayed to and/or from the remote WTRU 202. The WTRU 204-n may receive a SL RLC channel configuration upon reception of a PC5-RRC message from a remote WTRU 202 or via Uu RRC signaling. For example, the condition may be based on any of (and not limited to) the following SL RLC channel configuration parameters: (1) logical channel priority, (2) SL HARQ configuration, (3) SL RLC acknowledge mode/unacknowledged mode (AM/UM) configuration, and/or (4) a configuration parameter in a SL RLC channel configuration. For example, if the priority of at least one LCH is associated with data smaller than a threshold, the remote WTRU 202 may trigger a connection establishment. For example, if at least one of the LCHs associated with data has SL HARQ feedback enabled, the remote WTRU 202 may trigger connection establishment. For example, if at least one of the SL RLC channels is configured with SL RLC AM, the remote WTRU 202 may trigger connection establishment. For example, a configuration parameter (e.g., an explicit or implicit indication) in a SL RLC channel configuration may trigger connection establishment.

Coverage and/or Uu measurements may be one of the conditions described above. For example, a WTRU 204-n may be configured with a condition (e.g., trigger condition) based on a measured Uu signal and/or a coverage condition of a relay (e.g., in coverage, out of coverage, etc.). For example, the condition may be for the WTRU 204-n to be in coverage of a cell. If the condition is satisfied, the WTRU 204-n may initiate a connection establishment procedure upon reception of an SRB0 message.

A Uu bearer configuration of the WTRU 204-n itself may be one of the conditions described above. A WTRU 204-n may initiate a connection establishment upon reception of a message from a remote WTRU 202 based on a property associated with its own bearer configuration. For example, the WTRU 204-n may initiate a connection establishment procedure based whether or not the WTRU 204-n is itself configured with at least one Uu DRB. As another example, the WTRU 204-n may initiate a connection establishment procedure based on whether or not the WTRU 204-n is configured with at least on Uu DRB configured for low-latency or with a priority lower than a threshold. As another example, the WTRU 204-n may initiate a connection establishment procedure based whether or not the WTRU 204-n is configured with at least one Uu DRB that has been configured to trigger connection establishment (e.g., in certain conditions).

The RRC state(s) of any one or more (e.g., all) served remote WTRUs 202 of a WTRU 204-n and/or the RRC state(s) of any one or more (e.g., all) parent WTRUs 204-n of the WTRU 204-n may be one of the conditions described above.

An explicit and/or implicit indication from a remote WTRU 202 may be one of the conditions described above. An indication may be associated with a (e.g., dedicated) SL RLC channel or received in a message. For example, a WTRU 204-n may be configured with more than one SRB0 associated with a remote WTRU 202. On condition a message is received from a first SRB0, the WTRU 204-n may initiate a connection establishment. On condition the message is received from a second SRB0, the WTRU 204-n may not initiate a connection establishment. For example, a WTRU 204-n may receive an indication or a message in the SRB0 message itself, or along with the SRB0 message. For example, the indication may be a dedicated sidelink control information (SCI) itself, an indication in the SCI, a SL MAC CE, a field in a SL MAC CE (e.g., sent along with a Uu SRB0 message), a SL RRC message, and/or an IE in a SL RRC message (e.g., sent along with a Uu SRB0 message).

A number of remote WTRUs 202 served by the WTRU 204-n, either directly (e.g., single hop) and/or indirectly (e.g., including all remote WTRUs 202 connected over multiple hops) may be one of the conditions described above. For example, a WTRU 204-n may maintain a number of unicast links initiated for relaying which may correspond to a number of remote WTRUs 202 being served by the WTRU 204-n. For example, a WTRU 204-n may receive a control message indicating a number or list of subsequent (e.g., subsequent hops to) remote WTRUs 202 attached to the remote WTRU 202 of an immediate next hop. For example, a WTRU 204-n may send a control message indicating a number or list of subsequent, or next hop-attached remote WTRUs 202 to the next hop WTRU 204-n, such as upon a change in this number, upon reception of a message indicating a change in this number, periodically, or upon initiation of any Uu procedure by the said WTRU or another WTRU.

In certain representative embodiments, the particular triggering conditions may be configured and/or be specific to a particular SRB0, such as where a WTRU 204-n is configured with multiple SRB0s (e.g., each SRB0 may correspond to a different relayed path).

Remote WTRU Determination of Different Signaling to Relay WTRU based on Traffic Type

In certain representative embodiments, a remote WTRU 202 may determine a connection establishment behavior of a WTRU 204-n. A remote WTRU 202, upon satisfying a first condition, may inform a WTRU 204-n to perform a connection establishment/resume procedure. The remote WTRU 202, upon satisfying a second condition, may inform the WTRU 204-n to not perform a connection establishment/resume procedure. The remote WTRU 202 may signal this to the WTRU 204-n either explicitly and/or implicitly. For example, the remote WTRU 202 may (e.g., explicitly) signal the behavior by a flag or indication transmitted before and/or during the first RRC message to the WTRU 204-n. For example, the remote WTRU 202 may signal the behavior to the WTRU 204-n by any of (1) transmitting a first RRC message (e.g., SRB0) over a different SL SRB (e.g., associated with a different logical channel number); (2) transmitting the first RRC message (e.g., SRB0) along with a different SL RRC control element or message (e.g., the control element may identify the requested behavior of the WTRU 204-n); and/or (3) transmitting the first RRC message (e.g. SRB0) using a different SL PHY channel or control message (e.g., a different SCI).

In certain representative embodiments, a remote WTRU 202 may determine whether or not to inform and/or indicate to the WTRU 204-n to perform connection establishment based on any of: (1) SL measurements at the remote WTRU 202; (2) QoS and/or bearer of the data initiating the first RRC message by the remote WTRU 202; (3) RRC state of the remote WTRU 202; (4) Type of trigger; and/or (5) network indication.

For example, the SL measurements at the remote WTRU 202 may include any of CBR, SL RSRP, etc. On condition that at least one SL measurement (e.g., CBR) measured at the remote WTRU 202 is above a threshold, the remote WTRU 202 may indicate to the WTRU 204-n to perform a connection establishment procedure. Upon the SL RSRP measured by the remote WTRU 202 (e.g., of the WTRU 204-n) being below a threshold, the remote WTRU 202 may indicate to the WTRU 204-n to perform the connection establishment procedure.

For example, the remote WTRU 202 may be configured with one or more Uu bearers requiring a connected WTRU 204-n. If connection establishment by the remote WTRU 202 is triggered by one of these bearers, the remote WTRU 202 may indicate to the WTRU 204-n to perform connection establishment procedure.

For example, the remote WTRU 202 may indicate to the WTRU 204-n to perform connection establishment procedure when the remote WTRU 202 is in RRC_IDLE. For example, the remote WTRU 202 may not indicate to the WTRU 204-n to perform connection establishment procedure when the remote WTRU 202 is in RRC_INACTIVE.

For example, the type of trigger may be any of connection establishment, RAN notification area (RNA) (e.g., update), handover (HO), etc. As an example, whether the remote WTRU 202 may indicate to the WTRU 204-n to perform connection establishment may depend on a trigger and/or cause at the remote WTRU 202 for initiating the procedure via the WTRU 204-n.

For example, the network may provide an indication (e.g., in a paging message, a HO command, etc.) to the remote WTRU 202 which indicates whether or not to indicate to the remote WTRU 202 to initiate the connection establishment procedure. The indication may be implicit in the type (e.g., paging or HO) and/or content (e.g., whether a WTRU configuration is included in a configuration received by the remote WTRU 202) of a message to the remote WTRU 202 which triggers the connection establishment at the remote WTRU 202.

### Relay WTRU Using a Default Mapping

In certain representative embodiments, a WTRU 204-n may apply a default adaptation layer configuration when the network has not configured another adaptation layer (e.g., mapping of ingress bearers to egress bearers, SL RLC and/or Uu RLC channel configuration) has not been configured by the network (e.g., by dedicated signaling). A WTRU 204-n may apply a default adaptation layer configuration when a previously configured adaptation layer configuration has been released and/or deactivated by the WTRU 204-n. The default configuration may be specified or predefined.

For example, a default configuration may include any of a configuration obtained by broadcast system information (e.g., by SIB(s) for a WTRU 204-n inside of network coverage) or a preconfiguration (e.g., for a WTRU 204-n which is outside of network coverage). A WTRU 204-n may apply a dedicated configuration, such as on condition one is present (e.g., configured) at the WTRU. If not present, the WTRU 204-n may apply a default configuration. The WTRU 204-n may release an adaptation layer configuration upon any of the following actions and/or transitions: (1) the WTRU 204-n moves from RRC_CONNECTED to RRC_IDLE; (2) the WTRU 204-n moves from RRC_CONNECTED to RRC_INACTIVE; (3) the WTRU 204-n moves from RRC_INACTIVE to RRC_IDLE; (4) the WTRU 204-n performs IDLE and/or INACTIVE cell reselection from indirect to direct or vice versa, or between indirect to indirect between two relays (e.g., which belong to different cells, broadcast different cell identifiers or other different identifiers, belong to different RAN areas, and/or broadcast different RAN area identifiers); and/or the WTRU 204-n performs IDLE and/or INACTIVE cell reselection which results in a change of cell and/or RNA or similar that the relay is directly attached to, or that a next hop relay is attached to.

For example, a default adaptation layer configuration may include any of: one or more default SL RLCs, a Uu RLC egress channel configuration, and/or a default mapping. The default mapping may include associations between one or more (e.g., any) configured ingress RLC channel configurations and one or more default RLC egress channel configurations. The mapping may include an indication of the RLC channels, a next hop node (e.g., WTRU or gNB), and any potential prioritization information and/or behavior applied by the adaptation layer during the routing from ingress to egress.

For example, a dedicated adaptation layer configuration may include any of: a mapping from an RLC channel number (e.g., ID) in ingress to an RLC channel number in egress (e.g., ID), a mapping from a property (e.g., priority, RLC AM) of ingress to a property of egress, and/or a combination thereof. As an example, the WTRU 204-n may use an ID-based configuration for an ingress ID, and use a property based mapping when an ID mapping is not configured in the adaptation layer configuration.

As an example, a WTRU 204-n may be configured with an adaptation layer configuration in RRC_CONNECTED and may maintain such configuration when transitioning to RRC_INACTIVE. Upon transition to RRC_IDLE, upon cell reselection to a different cell and/or RNA or other similar area, or the WTRU 204-n connecting to a different cell and/r RNA or other similar area, the WTRU 204-n in RRC_INACTIVE may release the dedicated adaptation layer configuration and use the default adaptation layer configuration.

For example, a default configuration may indicate a mapping from a property (e.g., priority) of an ingress RLC channel to a corresponding property of an egress RLC channel. A property may include any one or more parameters associated with an RLC and/or MAC channel configuration for the RLC channel. These parameters may include any of: RLC AM/UM, LCH priority, SL HARQ enable/disable; LCH prioritized bit rate; LCH restrictions configured on a LCH; and/or minimum communication range (MCR). As another example, a default adaptation layer configuration may include a mapping rule which maps a LCH with priority less than x in ingress to a priority of y in egress (e.g., an egress LCH associated with priority of y).

### Multi-Hop WTRU Relay in IDLE/INACTIVE Determines Whether to Initiate Connection Establishment Upon Configuration of a SL RLC Channel

In certain representative embodiments, multi-hop WTRU relay in the IDLE and/or INACTIVE state may determine whether to initiate a connection establishment procedure upon configuration (e.g., by a remote WTRU 202) of a SL RLC channel, such as a new SL RLC channel configuration.

In certain representative embodiments, a WTRU 204-n may initiate a connection establishment procedure, a RNA procedure, a 2-step RACH procedure, a small data transmission procedure or the like, upon establishment of, configuration of and/or arrival of data at an ingress RLC channel (e.g., a SL RLC channel). The WTRU 204-n may receive a trigger to initiate the foregoing in a PC5-RRC message. The connection establishment or the like may be for the purpose of obtaining a dedicated adaptation layer configuration, or a configuration for an egress RLC channel configuration for an associated ingress RLC channel configuration. For example, the WTRU 204-n may initiate the procedure upon any or a combination of the following conditions: (1) the WTRU 204-n is not configured with an adaptation layer configuration, or is using a default adaptation layer configuration; (2) the default adaptation layer configuration or the adaptation layer configuration currently being used by the WTRU 204-n does not provide a mapping for the type of RLC channel that is established and/or configured (e.g., the type of RLC channel may be associated with a QoS property of the channel and/or a parameter associated with the RLC channel, such as a priority); (3) the WTRU 204-n is in a (e.g., specified) RRC state (e.g. IDLE, INACTIVE, or CONNECTED); (4) the coverage condition of the WTRU 204-n (e.g., the WTRU 204-n is in coverage, or out of coverage, such as where an out of coverage connection establishment may be performed via a next hop WTRU-to-NW relay); (5) the WTRU 204-n does not support the RLC channel configuration configured by the remote WTRU 202; and/or (6) the priority of the ingress RLC channel is larger than a threshold.

For example, a WTRU 204-n may initiate a connection establishment when the WTRU 204-n is in coverage, and is not configured with a mapping of an ingress RLC channel to an egress RLC channel (e.g., in a dedicated configuration and/or in a default configuration).

For example, a WTRU 204-n may initiate a connection establishment when the relay WTRU is not configured with a dedicated configuration by ID, and the priority of the established ingress RLC channel is above a threshold.

### Relay/Remote WTRU Determination of a Hop Count or Path Weight

A (e.g., intermediate) WTRU 204-n and/or a remote WTRU 202 may determine a hop count, which may be associated with one or more remote WTRUs 202 and/or paths. A hop count may include a number of relay WTRUs which separates a remote WTRU 202 and/or WTRU 204-n from the Uu connection to the gNB. A hop count may include a cumulative weight value associated with a path towards the gNB (or a destination WTRU in the case of WTRU-to-WTRU relay). For example, the weight may be a measure of latency across a path or associated with one or more hops. For example, the weight may be determined by the WTRU 204-n, such as by adding a specific value (e.g., incrementing by a value, such as 1, in the case it represents a hop count) to a value obtained from a next hop relay. For example, a WTRU 204-n that communicates via the Uu interface (e.g., directly) may set the hop count to a default or (pre)configured value (e.g., 0). The latency (e.g., weight) for a given hop may be determined at the WTRU 204-n by any of: (1) RRC state of the WTRU 204-n; (2) a property associated with the SL RLC channels; (3) a configuration of SL Uu channels (e.g., for relaying and/or RRC messaging), such as the mapping; (4) a property associated with the Uu interface and/or SL channels (e.g., access count and/or frequency of access); (5) a property associated with an SL resource pool; and/or (6) a number of remote WTRUs 202 served by the WTRU 204-n.

For example, the WTRU 204-n may be configured with a value of the latency (e.g., weight) for each possible RRC state (e.g., a first weight for RRC_CONNECTED, a second weight for RRC_INACTIVE, and a third weight for RRC_IDLE).

For example, the WTRU 204-n may determine the latency (e.g., weight) based on the property associated with the SL RLC channels and/or a mapping configuration corresponding to SL Uu channels associated with relaying of data and/or RRC messaging. As an example, the weight may be a function of the highest or lowest priority of SL RLC channels and/or Uu channels associated with relaying at the WTRU 204-n. As another example, the weight may be a function of the priority (or any other configured property) of the Uu channel to which SL RLC channels carrying SRB0 and/or SRB1 are mapped. As another example, the latency (e.g., weight) may be configured (explicitly or implicitly) in the SL RLC channels and/or the adaptation layer configuration associated with the mapping of the SL RLC channels to the Uu RLC channels.

For example, the WTRU 204-n may determine the latency (e.g., weight) based on an operating frequency of the WTRU 204-n. For example, the latency (e.g., weight) may be a function of a frequency range that the channel is in, such as FR1 or FR2 (or a frequency band of the channel). For example, the weight may be a function of whether the channel is licensed or unlicensed (e.g., uses LBT access).

For example, the WTRU 204-n may determine the latency (e.g., weight) based on at least one property associated with the SL resource pool on SL. The weight may be a function of sensing mechanisms configured for the pool (e.g., random selection, partial sensing, full sensing). The weight may be a function of the measured CBR. The weight may be a function of the density of the SL resource pool. The weight may be explicitly configured in the pool configuration.

For example, the WTRU 204-n may determine the latency (e.g., weight) based on the number of remote WTRUs 202. The weight may be a function of the number of remote WTRUs 202 currently served by the WTRU 204-n.

In certain representative embodiments, a (e.g., intermediate) WTRU 204-n may transmit a hop count and/or cumulative weight, such as to one or more remote WTRUs (e.g., which are served by the WTRU-to-NW relay). For example, the WTRU 204-n may include the hop count and/or cumulative weight in any of: a discovery transmission by the WTRU 204-n, a PC5-RRC message transmitted to a remote WTRU 202 (e.g., provided to the remote WTRU 202 either directly or upon a request by the remote WTRU 202, e.g., via a hop count request message), a SL L2 and/or L1 message (e.g., SCI transmission, a SL MAC CE), and/or an adaptation layer control message.

In certain representative embodiments, a (e.g., intermediate) WTRU 204-n may transmit information indicating a hop count and/or cumulative weight upon being triggered. For example, the WTRU 204-n may transmit the hop count and/or cumulative weight information upon a change of the hop count maintained by the WTRU 204-n, such as when triggered by a mobility procedure initiated by the relay WTRU 204-n (e.g., relay/cell reselection, re-establishment) or by the network (e.g., handover, group handover, conditional HO (CHO), change of relay, direct and/or indirect mobility procedure or vice versa, etc.), or by a change in the RRC state of the relay WTRU 204-n. As another example, the relay WTRU 204-n may transmit the hop count and/or cumulative weight information upon reconfiguration, by the network, of the hop count maintained by the relay WTRU 204-n.

### Relay/Remote WTRU Use of Hop Count/Path Weight to Determine Connection Management Timer

In certain representative embodiments, a WTRU (e.g., a remote WTRU 202 and/or relay WTRU 204-n) may use the hop count and/or weight information (e.g., cumulative or obtained from another relay WTRU 204-n, such as a next hop relay) to determine the value of a timer associated with one or more connection management actions. For example, the hop count and/or weight information may be used to determine any of: (1) a connection establishment timer (e.g., T300 or similar timer), (2) a connection resume timer (e.g., T319 or similar timer), (3) a re-establishment timer (e.g., T301 or similar timer), (4) a timer associated with completion of a mobility procedure (e.g., T304 or similar timer), (5) a timer for a MCGFailureInformation procedure (e.g., T316 or similar timer), and/or a timer for transmission of a DedicatedSIBRequest message (e.g., a T350 message).

For example, the WTRU may scale the value of a network configured timer by the value of, or a function of the value of, the hop count and/or path weight. In another example, the WTRU may be configured with different values of a network configured timer to be used with each value of (or ranges of values) the hop count/path weight. The WTRU may then use the value of the timer which is associated with or configured with the hop count/path weight.

### Relay/Remote WTRU Use of Hop Count/Path Weight to Select Relay

In certain representative embodiments, a WTRU (e.g., a remote WTRU 202 and/or relay WTRU 204-n) may use the hop count and/or weight information (e.g., cumulative or obtained from another relay WTRU 204-n, such as a next hop relay) to select a relay WTRU 204-n. For example, the remote WTRU 202 may select a relay which is associated with a smaller hop count among plural remote WTRUs 202.

### WTRU Connection Establishment Procedure for Multi-Hop Relays

In certain representative embodiments, a relay WTRU 204-n, upon reception of a first RRC message from a remote WTRU 202 (e.g., indicating connection establishment/resume of the remote WTRU 202), and potentially and upon determination to initiate its own connection establishment procedure, may indicate its own request to initiate a connection establishment (or to resume a connection) to the network.

The relay WTRU 204-n may transmit a separate Uu RRC message (e.g., RRCSetupRequest or RRCResumeRequest) along with the received and forwarded message on SRB0. For example, the relay WTRU 204-n may determine to initiate connection establishment upon the reception of the SRB0 message from the remote WTRU 202, and the relay WTRU 204-n may initiate transmission of an RRCSetupRequest (or RRCResumeRequest) message at the relay WTRU 204-n. The transmission may be over the relayed path or may be over a direct Uu path, if one is available.

The relay WTRU 204-n may encapsulate the received message on SRB0 onto its own RRC message transmitted to the (e.g., default) SRB0 for transmission, or the Uu SRB channel, if available.

The relay WTRU 204-n may create a new Uu RRC message (e.g., encapsulating the received message from the remote WTRU 202) without forwarding the received message. For example, the relay WTRU 204-n may determine to initiate a connection establishment/resume procedure and create a new RRC message (e.g., encapsulating the received message on SRB0 For example, the relay WTRU 204-n may determine not to initiate a connection establishment/resume, the relay WTRU 204-n may forward the received SRB0 message to the default (or specified) SL RLC channel for transmission. The relay WTRU 204-n may use a different default or specified SL RLC channel for transmission for each of the cases.

The relay WTRU 204-n may establish a new SL RLC channel for reception of a response message (e.g., SRB1) to the SRB0 transmission.

The relay WTRU 204-n may determine (e.g., change) the reception behavior for the SL RLC channel associated with the response (e.g., SRB1) depending on its own request to transition to RRC_CONNECTED. For example, after a relay WTRU 204-n decides to initiate a connection establishment upon reception of an SRB0 message from a remote WTRU 202, the relay WTRU 204-n may determine to route (e.g., all) subsequent received messages on an SL RLC channel for reception of a response message (e.g., Uu SRB1) to upper layers, rather than to a next hop. As another example, the relay WTRU 204-n may determine to route (e.g., all) subsequent received messages on an SL RLC channel, other than the SL RLC channel for reception of the response message, forward to a next hop.

### Relay WTRU Configured With and Autonomously Disables State Transition Timers

An (e.g., intermediate) relay WTRU 204-n may be configured with a timer (e.g., time duration) for triggering autonomous state transition from one RRC state to another RRC state (e.g., from RRC_CONNECTED to RRC_IDLE/INACTIVE, or from RRC_INACTIVE to RRC_IDLE) upon lapsing. The timer may be started (or restarted) based on any of: (1) reception of DCI scheduling from the network, such as where the DCI schedules SL transmission, (2) reception of an RRC message from the network, (3) reception of an acknowledgement from the network associated with an UL transmission, (4) reception of data on a relayed RLC channel (e.g., in the UL or DL direction), and/or (5) an indication from one or more (e.g., all) of the attached remote WTRUs 202 that the WTRUs have moved to RRC_IDLE and/or RRC_INACTIVE, have no active data to be transmitted (e.g., relayed), or have initiated SL DRX behavior.

In certain representative embodiments, a timer may be started (e.g., a time duration may be configured) with different values which may depend on a triggering condition for the timer as described herein. For example, the relay WTRU 204-n may start a timer with value T1 upon reception of an RRC message from the network, with a value of T2 upon reception of data in the UL direction (e.g., from a remote WTRU 202), and/or with a value of T3 upon the reception of data in the DL direction (e.g., from the gNB or another relay WTRU 204-n that is destined to the remote WTRU 202).

Upon expiry of the timer (e.g., the time duration has elapsed), the (e.g., intermediate) relay WTRU 204-n may transition to another RRC state.

For example, a relay WTRU 204-n may disable one or more autonomous state transition timers when configured as a relay WTRU 204-n. The disabling of the one or more timers may depend on whether the relay WTRU 204-n is an intermediate relay WTRU 204-n or a final relay. The disabling of the one or more timers may (e.g., further) depend on similar conditions as the decision to move to RRC_CONNECTED following the reception of a trigger from a remote WTRU 202 as described herein.

For example, an (e.g., intermediate) relay WTRU 204-n may disable the starting of a timer associated with a trigger of moving from RRC_CONNECTED to RRC_IDLE and/or RRC_INACTIVE when the relay WTRU 204-n is RRC_CONNECTED and receiving a control channel (e.g., RRC messaging and/or DCI) directly from the Uu interface. An (e.g., intermediate) relay may (e.g., further) disable the starting of a timer if the relay WTRU 204-n itself has no active data transmissions for its own bearers (e.g., is not configured with any DRBs initiated at the relay WTRU 204-n). An (e.g., intermediate) relay WTRU 204-n may (e.g., further) disable the starting of a timer based on the QoS of the data transmissions associated with the remote WTRU 202 which may be determined from, for example, information provided by the remote WTRU 202, information provided by the network, and/or a configuration property associated with the SL RLC channels of the remote WTRU 202 as described herein.

### Relay/Remove WTRU Behavior Upon Reception of a Reject/Failure Message

In certain representative embodiments, a WTRU (e.g., a relay WTRU 204-n and/or a remote WTRU 202) may receive a reject message or a failure message following initiation of (i) a connection establishment procedure or (ii) a similar procedure initiated via a relay WTRU 204-n.

The reject or failure message may be a PC5-RRC message, a Uu RRC message (e.g., sent by the network) or a combination thereof (e.g., a Uu RRC message encapsulated or combined with a PC5-RRC message). A relay WTRU 204-n may send a reject or failure message to a remote WTRU 202 (or a relay WTRU 204-n it is serving) as a result of a failed connection establishment. A relay WTRU 204-n may send an indication of its own failed connection establishment to a remote WTRU 202 (or a relay WTRU 204-n it is serving).

For example, a WTRU 102 (e.g., a relay WTRU 204-n and/or a remote WTRU 202) may perform one or more different behaviors upon reception of a reject or failure message. The WTRU (e.g., a relay WTRU 204-n and/or a remote WTRU 202) may, upon receiving a reject or failure message, perform any of: (1) generating and/or forwarding the reject or failure message to a next hop (e.g., towards the remote WTRU 202); (2) initiating a cell/relay reselection procedure; (3) initiating a Uu reestablishment procedure; (4) tearing down (e.g., removing) an established unicast link with a remote or relay WTRU 204-n; (5) maintaining the PC5-RRC connection with the relay WTRU 204-n following the failure; and/or (6) retrying the connection establishment procedure. For example, the WTRU may initiate (e.g., retry) the connection establishment procedure after the reception of the reject or failure message following the expiry (e.g., lapsing) of a timer which was started at reception of the reject or failure message and/or following an indication from another WTRU which sent the reject or failure message that connection establishment can be retried. For example, the WTRU may retry the connection establishment procedure a number of configured times.

For example, a WTRU 102 (e.g., a relay WTRU 204-n and/or a remote WTRU 202) may (e.g., further) determine which of the above behaviors to perform depending on information (e.g., an indication) provided in the reject or failure message, a type of the reject or failure message, and/or the RRC state of the relay WTRU 204-n and/or the remote WTRU 202.

The relay WTRU 204-n which sends a reject or failure message may indicate (e.g., implicitly or explicitly) whether the attached remote WTRU 202 may perform one of the above behaviors versus another behavior, such as based on a reason for the failure. For example, a relay WTRU 204-n may send a first failure or reject message (e.g., including a first indication) when the relay WTRU's own connection establishment procedure fails, and may send a second failure or reject message (e.g., including a second indication) when the relay WTRU 204-n receives a failure or reject message from its own next hop relay. In certain representative embodiments, the remote WTRU 202 may perform relay and/or cell reselection when receiving the first failure or reject message. In certain representative embodiments, the remote WTRU 202 may maintain the PC5-RRC connection with the relay WTRU 204-n and/or may retry the connection procedure after a time duration has elapsed from when the second indication is received. As another example, a relay WTRU 204-n or a remote WTRU 202 may initiate a Uu re-establishment procedure upon reception of a PC5-RRC reconfiguration failure message received by another relay WTRU 204-n (e.g., a next hop). The PC5-RRC reconfiguration failure message may be received following transmission of a PC5-RRC reconfiguration to the WTRU.

In certain representative embodiments, a relay WTRU 204-n, upon reception of a first RRC message from a remote WTRU 202 (e.g., indicating connection establishment/resume of the remote WTRU 202), may forward or encapsulate the first RRC message from the remote WTRU 202 as described herein. The relay WTRU 204-n may receive a reject message or a failure message following initiation of a connection establishment or similar procedure. The relay WTRU 204-n may send a reject or failure message to the remote WTRU 202 (or the relay WTRU 204-n it is serving) as a result of the failed connection establishment. For example, the relay WTRU 204-n may send an indication of its own failed connection establishment to a remote WTRU 202 (or a relay WTRU 204-n it is serving). The relay WTRU 204-n may send a first failure or reject message (e.g., including a first indication) when the relay WTRU's own connection establishment procedure fails, and may send a second failure or reject message (e.g., including a second indication) when the relay WTRU 204-n receives a failure or reject message from its own next hop relay. The relay WTRU 204-n which sends the reject or failure message may indicate (e.g., implicitly or explicitly) a reason for the failure (e.g., whether the message is a PC5-RRC message from a next hop relay or a Uu RRC message from the network).

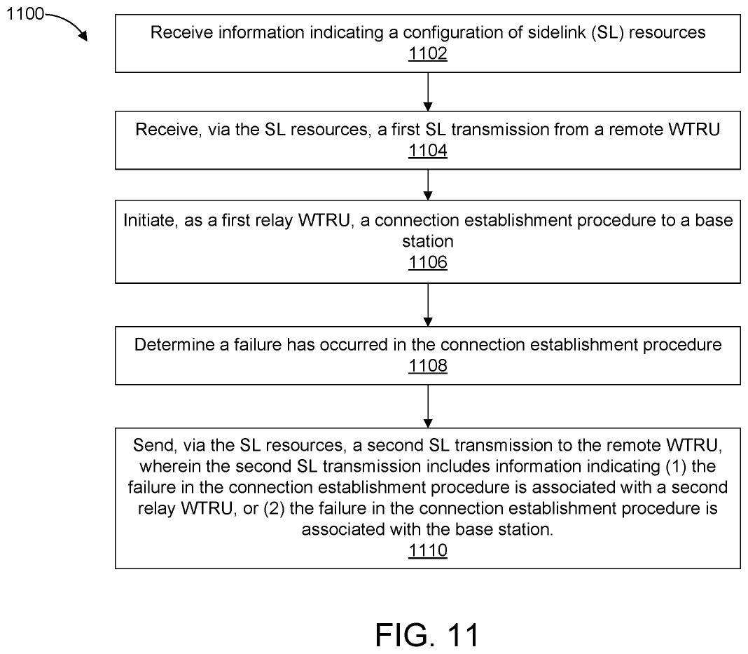

FIG. 11 is a diagram illustrating a representative embodiment of a multi-hop relay communication procedure 1100. The multi-hop relay communication procedure 1100 may be implemented by a WTRU 102. For example, the WTRU 102 may serve as a relay (e.g., a first relay WTRU 204-1, second relay WTRU 204-2, etc.) WTRU 204-n on a multi-hop path between another (e.g., remote) WTRU 202 and a base station (e.g., gNB 180 of a RAN 104/113). One or more other (e.g., intermediate) relay WTRUs 204-n may be disposed as part of the multi-hop path between the relay WTRU 204-1 and the remote WTRU 202 and/or the relay WTRU 204-2 and the base station. At 1102, the WTRU 102 may receive information indicating a configuration of sidelink (SL) resources. For example, the information indicating the configuration of the SL resources may be received from the base station. The SL resources may be shared by any WTRUs on the multi-hop path and/or may include time resources (e.g., slots) and/or frequency resources (e.g., resource blocks in a bandwidth part). At 1104, the (e.g., relay) WTRU 102 may receive, via the SL resources, a first SL transmission from a remote WTRU 202. For example, the first SL transmission may include data and/or control signaling. In certain representative embodiments, the first SL transmission may be or include a connection establishment request (e.g., RRCSetupRequest, RRCReestablishmentRequest, RRCResumeRequest) for the remote WTRU 202 to connect to the base station. At 1106, the WTRU 102 may initiate (e.g., as a relay WTRU 204-1) a connection establishment procedure to (e.g., with) a base station. For example, the connection establishment procedure may be performed as shown in any of FIGS. 7, 8 and/or 10 via one or more of the other relay WTRUs 204-n, such as in FIGS. 5 and/or 6 where two or more intermediate relay WTRUs 204-2 may provide a multi-hop path to the base station. At 1108, the WTRU 102 may determine that a failure has occurred in the connection establishment procedure. At 1110, the WTRU 102 may send, via the SL resources, a second SL transmission to the remote WTRU 202. For example, the second SL transmission may include information indicating (1) the failure in the connection establishment procedure is associated with a second (e.g., next hop) relay WTRU (e.g., relay WTRU 204-2), or (2) the failure in the connection establishment procedure is associated with the base station.

In certain representative embodiments, the first SL transmission received at 1104 by the (e.g., relay) WTRU 102 may include information indicating a Uu connection establishment request associated with the remote WTRU 202.

In certain representative embodiments, the determination, by the WTRU 102, the failure has occurred in the connection establishment procedure may include to receive, by the (e.g., relay) WTRU 102, a third (e.g., SL) transmission (e.g., from the second relay WTRU 204-2, 204-n) including information indicating the failure has occurred in the connection establishment procedure.

For example, the third transmission may include a PC5 failure message having information indicating the failure in the connection establishment procedure is associated with a second relay WTRU (e.g., relay WTRU 204-2, 204-n), and the second SL transmission may include the information indicating (1) the failure in the connection establishment procedure is associated with the second relay WTRU.

For example, the third transmission may include a Uu failure message having information indicating the failure in the connection establishment procedure is associated with the base station, and the second SL transmission may include the information indicating (2) the failure in the connection establishment procedure is associated with the base station.

In certain representative embodiments, the determination, by the (e.g., relay) WTRU 102, that the failure has occurred in the connection establishment procedure may include to receive, by the WTRU 102, a third (e.g., SL) transmission (e.g., from the second relay WTRU 204-2, 204-n) associated with a PC5 protocol stack or a Uu protocol stack

For example, where the third transmission is associated with the PC5 protocol stack (e.g., of the WTRU 102), the second SL transmission may include the information indicating (1) the failure in the connection establishment procedure is associated with the second relay WTRU (e.g., relay WTRU 204-2, 204-n).

For example, where the third transmission is associated with the Uu protocol stack (e.g., of the WTRU 102), the second SL transmission may include the information indicating that (2) the failure in the connection establishment procedure is associated with the base station.

For example, where the third transmission is a PC5 message (or associated with the PC5 protocol stack), the WTRU 102 may send the second SL transmission which includes the information indicating (1) the failure in the connection establishment procedure is associated with the second relay WTRU (e.g., relay WTRU 204-2, 204-n) as a source of the failure.

For example, where the third transmission is a Uu message (or associated with the Uu protocol stack), the WTRU 102 may send the second SL transmission which includes the information indicating (2) the failure in the connection establishment procedure is associated with the base station as a source of the failure.

In certain representative embodiments, the determining, by the (e.g., relay) WTRU 102, the failure has occurred in the connection establishment procedure may include determining that a time interval has lapsed. For example, the time interval may be associated with (e.g., determined using) hop count information of the multi-hop relay path. As an example, the WTRU 102 may determine that the time interval, from when the connection establishment procedure is initiated, has lapsed without completing the connection establishment procedure (e.g., the time interval lapses prior to receiving a RRCSetup, RRCReestablishment, and/or RRCResume message). In some embodiments, the WTRU 102 may associate the time interval with a PC5 interface (e.g., a PC5 connection request) to the second relay WTRU (e.g., relay WTRU 204-2, 204-n). In some embodiments, the WTRU 102 may associate the time interval with a Uu interface (e.g., a Uu connection request) to the base station. In some embodiments, the WTRU 102 may associate a first time interval with a PC5 interface to the second relay WTRU (e.g., relay WTRU 204-2, 204-n) and a second time interval with a Uu interface to the base station.

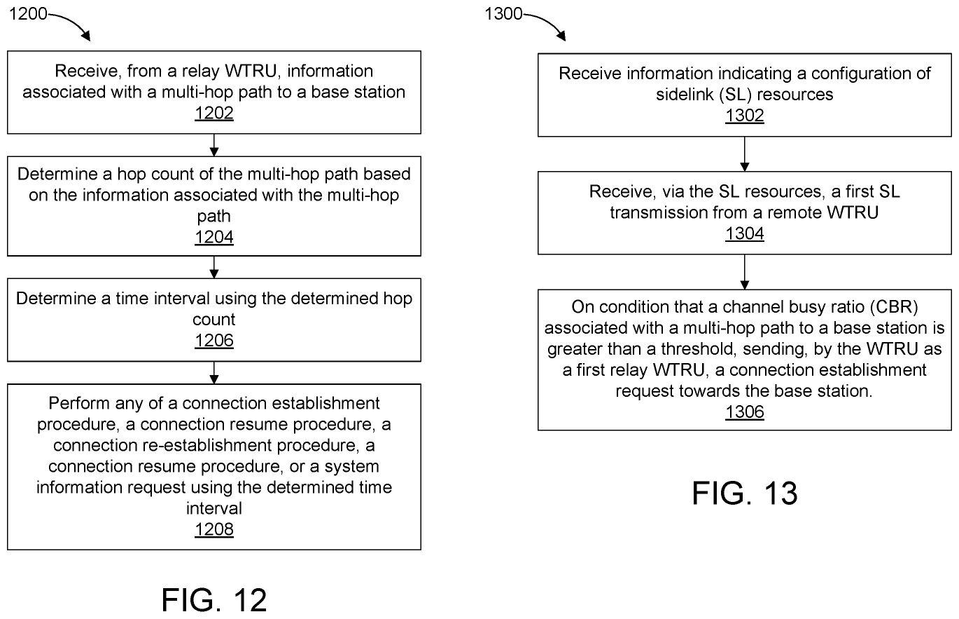

FIG. 12 is a diagram illustrating a representative embodiment of another multi-hop relay communication procedure 1200. The multi-hop relay communication procedure 1200 may be implemented by a WTRU 102. For example, the WTRU 102 may serve as a relay WTRU (e.g., a first relay WTRU 204-1, second relay WTRU 204-2, etc.) 204-n on a multi-hop path between a remote WTRU 202 and a base station (e.g., gNB 180 of a RAN 104/113). One or more other (e.g., intermediate) relay WTRUs 204-n may be disposed as part of the multi-hop path between the relay WTRU 204-1 and the remote WTRU 202 and/or the relay WTRU 204-2 and the base station. At 1202, the (e.g., first relay) WTRU 102 may receive, from a (e.g., another) relay WTRU 204-n, information associated with a multi-hop path to a base station. At 1204, the (e.g., relay) WTRU 102 may determine a hop count of the multi-hop path based on the information associated with the multi-hop path. For example, the information associated with the multi-hop path may represent a number of hops and/or a connection state of each hop (e.g., each relay WTRU 204-n) to the base station. As an example, the number of hops and/or the connection state of each hop may be indicated by a cumulative weight value determined by the next hop (e.g., the other relay WTRU 204-n of 1202). At 1204, the (e.g., relay) WTRU 102 may determine the hop count by modifying the information received at 1202. At 1206, the (e.g., relay) WTRU 102 may proceed to determine a time interval using (e.g., based at least in part on) the determined hop count. For example, the time interval may be used to set a timer for connection management. At 1208, the (e.g., relay) WTRU 102 may perform any of a connection establishment procedure, a connection re-establishment procedure, a connection resume procedure, or a system information request using the determined time interval.

In certain representative embodiments, the information associated with the multi-hop path which is received at 1202 includes information indicating a number of hops (e.g., on the multi-hop path) from the (e.g., other) relay WTRU 204-n to the base station.

In certain representative embodiments, the determining of the hop count may include the (e.g., relay) WTRU 102 modifying the hop count. For example, the relay WTRU 204-1 may modify the hop count based on a connection state (e.g., RRC_CONNECTED, RRC_INACTIVE, RRC_IDLE) of the relay WTRU 204-1, a property associated with SL RLC channels and/or Uu RLC channels, operating frequency (e.g., FR1, FR2, licensed spectrum, or unlicensed spectrum), a property of configured SL resources (e.g., SL resource pool), and/or a number of remote WTRUs 202 which are served by the relay WTRU 204-1 or otherwise associated with the multi-hop path.

In certain representative embodiments, the relay WTRU 204-1 may send to another WTRU (e.g., a remote WTRU 202 or a child relay WTRU 204-n), information indicating the modified hop count. For example, the information indicating the modified hop count may be included in any of a broadcast (e.g., discovery) message, a sidelink message, and/or control signaling (e.g., SCI, SL MAC CE, RLC, and/or RRC).

In certain representative embodiments, the relay WTRU 102 may send information indicating the modified hop count after any of relay WTRU selection, cell selection, connection establishment (or connection re-establishment or the connection resuming), handover, registration, sending of a service request, and/or updating of the hop count.

FIG. 13 is a diagram illustrating a representative embodiment of another multi-hop relay communication procedure 1300. The multi-hop relay communication procedure 1300 may be implemented by a WTRU 102. For example, the WTRU 102 may serve as a relay WTRU (e.g., a first relay WTRU 204-1, second relay WTRU 204-2, etc.) on a multi-hop path between a remote WTRU 202 and a base station (e.g., gNB 180 of a RAN 104/113). One or more other (e.g., intermediate) relay WTRUs 204-n may be disposed as part of the multi-hop path between the relay WTRU 204-1 and the remote WTRU 202 and/or the relay WTRU 204-2 and the base station. At 1302, the WTRU 102 may receive information indicating a configuration of SL resources. At 1304, the WTRU 102 may receive (e.g., as a relay WTRU), via the SL resources, a first SL transmission from a remote WTRU 202. After 1304, on condition that a channel busy ratio (CBR) associated with the multi-hop path (e.g., assoc. w/the remote WTRU 202 and/or the second relay WTRU 204-2) to the base station is greater than a threshold, the WTRU 102 (e.g., as a first relay WTRU 204-1) may send a connection establishment request towards the base station (e.g., to a second relay WTRU 204-2 on the multi-hop path) at 1306. For example, the WTRU 102 may determine the CBR with respect to any of the remote WTRU 202 and/or a second relay WTRU 204-2 on the multi-hop path.

In certain representative embodiments, the WTRU 102 may be configured with a value for the threshold (e.g., associated with the SL resources). For example, the threshold may be based on a quality of service (QoS) (e.g., of a SL RLC configuration associated with the remote WTRU 202) and/or a hop count to the base station (e.g., cumulative weight). The SL RLC configuration may include one or more radio bearers, such as DRBs and/or SRBs associated with the remote WTRU 202.

In certain representative embodiments, the WTRU 102 may receive, from a second relay WTRU 204-2 (e.g., along the multi-hop path), information associated with the multi-hop path to the base station. The WTRU 102 may determine a hop count and/or cumulative weight of the multi-hop path based on the information associated with the multi-hop path.

In certain representative embodiments, the threshold may be based on (e.g., determined using) the hop count and/or the cumulative weight. For example, the threshold may be based on the determined hop count (or cumulative weight) and a quality of service (QoS) associated with a SL radio link control (RLC) configuration. As an example, the SL RLC configuration may include one or more radio bearers (e.g., SRBs and/or DRBs) associated with the remote WTRU 202. For example, the first SL transmission at 1304 may be received by the (e.g., first relay) WTRU 102 using the one or more radio bearers of the SL RLC configuration.

In certain representative embodiments, the WTRU 102 may determine a time interval (e.g., value for a timer) using the determined hop count. The time interval (e.g., timer value) may be associated with connection management by the WTRU 102 as described herein. For example, on condition that the time interval (e.g., from the sending of the connection request message at 1306) has lapsed prior to receiving a connection setup message or a connection reject message, the WTRU 102 may determine that a connection establishment procedure to the base station has failed.

In certain representative embodiments, the WTRU 102 may receive a connection setup message. After receiving the connection setup message, the (e.g., first relay) WTRU 102 may relay (e.g., to a next hop parent relay WTRU 204-n) one or more second SL transmissions (e.g., received) from the remote WTRU 202 using a (e.g., network configured or default) mapping. For example, the mapping may associate of one or more first radio bearers (e.g., SRBs and/or DRBs), or ingress channels, associated with the remote WTRU 202 and one or more second radio bearers, or egress channels, associated with the second relay WTRU.

In certain representative embodiments, the WTRU 102 may receive from the network (e.g., be configured with) the mapping. For example, the mapping may be an adaptation layer configuration. For example, the mapping may associate ingress channels (e.g., SL RLC, Uu RLC IDs) with egress channels, ingress properties with egress properties, and/or prioritization of ingress to egress (e.g., a priority of the one or more first radio bearers to one of the one or more second radio bearers). Examples of default and dedicated adaptation layer configurations are described elsewhere herein.

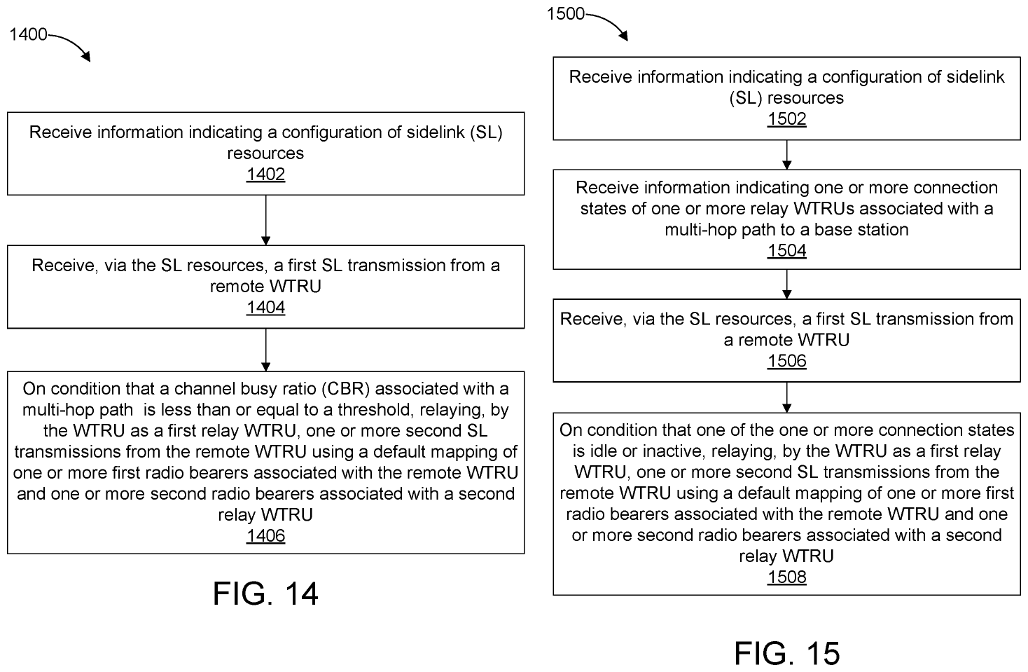

FIG. 14 is a diagram illustrating a representative embodiment of another multi-hop relay communication procedure 1400. The multi-hop relay communication procedure 1400 may be implemented by a WTRU 102. For example, the WTRU 102 may serve as a relay WTRU (e.g., a first relay WTRU 204-1, second relay WTRU 204-2, etc.) on a multi-hop path between a remote WTRU 202 and a base station (e.g., gNB 180 of a RAN 104/113). One or more other (e.g., intermediate) relay WTRUs may provide as part of the multi-hop path between the relay WTRU 204-1 and the remote WTRU 202 and/or the relay WTRU 204-2 and the base station. At 1402, the (e.g., relay) WTRU 102 may receive information indicating a configuration of sidelink (SL) resources. After 1402, the WTRU 102 may receive, via the SL resources, a first SL transmission from a remote WTRU 202 at 1404. At 1406, on condition that a channel busy ratio (CBR) associated with a multi-hop path (e.g., assoc. w/the remote WTRU 202 and/or the second relay WTRU 204-2) to a base station is less than or equal to a threshold, the (e.g., first relay) WTRU 102 may relay (e.g., to a next hop parent relay WTRU) one or more second SL transmissions (e.g., received) from the remote WTRU 202 using a default mapping. For example, the default mapping may associate of one or more first radio bearers (e.g., SRBs and/or DRBs), or ingress channels, associated with the remote WTRU 202 and one or more second radio bearers, or egress channels, associated with the second relay WTRU 204-2.

In certain representative embodiments, the WTRU 102 may be configured with a value for the threshold (e.g., associated with the SL resources). For example, the threshold may be based on a quality of service (QoS) (e.g., of a SL RLC configuration associated with the remote WTRU 202) and/or a hop count to the base station (e.g., cumulative weight). The SL RLC configuration may include one or more radio bearers, such as DRBs and/or SRBs associated with the remote WTRU 202.

In certain representative embodiments, the (e.g., first relay) WTRU 102 may receive, from a second relay WTRU 204-2 (e.g., along the multi-hop path), information associated with the multi-hop path to the base station. The WTRU 102 may determine a hop count and/or cumulative weight of the multi-hop path based on the information associated with the multi-hop path.

In certain representative embodiments, the threshold may be based on (e.g., determined using) the hop count and/or the cumulative weight. For example, the threshold may be based on the determined hop count (or cumulative weight) and a quality of service (QoS) associated with a SL radio link control (RLC) configuration. As an example, the SL RLC configuration may include one or more radio bearers (e.g., SRBs and/or DRBs) associated with the remote WTRU 202. For example, the first SL transmission at 1304 may be received by the (e.g., first relay) WTRU 102 using the one or more radio bearers of the SL RLC configuration.

In certain representative embodiments, the WTRU 102 may receive from the network (e.g., be configured with) the default mapping. For example, the default mapping may be a default adaptation layer configuration. For example, the default mapping may associate ingress channels (e.g., SL RLC, Uu RLC IDs) with egress channels, ingress properties with egress properties, and/or prioritization of ingress to egress (e.g., a priority of the one or more first radio bearers to one of the one or more second radio bearers). Examples of default adaptation layer configurations are described elsewhere herein.

FIG. 15 is a diagram illustrating a representative embodiment of another multi-hop relay communication procedure 1500. The multi-hop relay communication procedure 1500 may be implemented by a WTRU 102. For example, the WTRU 102 may serve as a relay WTRU (e.g., a first relay WTRU 204-1, second relay WTRU 204-2, etc.) on a multi-hop path between a remote WTRU 202 and a base station (e.g., gNB 180 of a RAN 104/113). One or more other (e.g., intermediate) relay WTRUs 204-n may be disposed as part of the multi-hop path between the first relay WTRU 204-1 and the remote WTRU 202 and/or the second relay WTRU 204-2 and the base station. At 1502, the WTRU 102 may receive information indicating a configuration of sidelink (SL) resources. At 1504, the WTRU 102 may receive information indicating one or more connection states (e.g., RRC_CONNECTED, RRC_IDLE, RRC_INACTIVE) of one or more of the other relay WTRUs 204-n associated with the multi-hop path to the base station. At 1506, the WTRU 102 may receive, via the SL resources, a first SL transmission from a remote WTRU 202. After 1506, on condition that any (e.g., at least one) of the one or more connection states is idle or inactive, the (e.g., first relay) WTRU 102 may relay (e.g., to a next hop parent relay WTRU) one or more second SL transmissions (e.g., received) from the remote WTRU 202 using a default mapping at 1508.

In certain representative embodiments, the WTRU 102 may receive from the network (e.g., be configured with) the default mapping. The WTRU 102 may receive the default mapping prior to 1504 in FIG. 15. For example, the default mapping may be a default adaptation layer configuration. For example, the default mapping may associate ingress channels (e.g., SL RLC, Uu RLC IDs) with egress channels, ingress properties with egress properties, and/or prioritization of ingress to egress (e.g., a priority of the one or more first radio bearers to one of the one or more second radio bearers). Examples of default adaptation layer configurations are described elsewhere herein.

In certain representative embodiments, the WTRU 102 may determine its own connection state at 1506. At 1508, the WTRU 102 may, on condition that its own connection state is idle or inactive, relay one or more second SL transmissions (e.g., received) from the remote WTRU 202 using the default mapping.

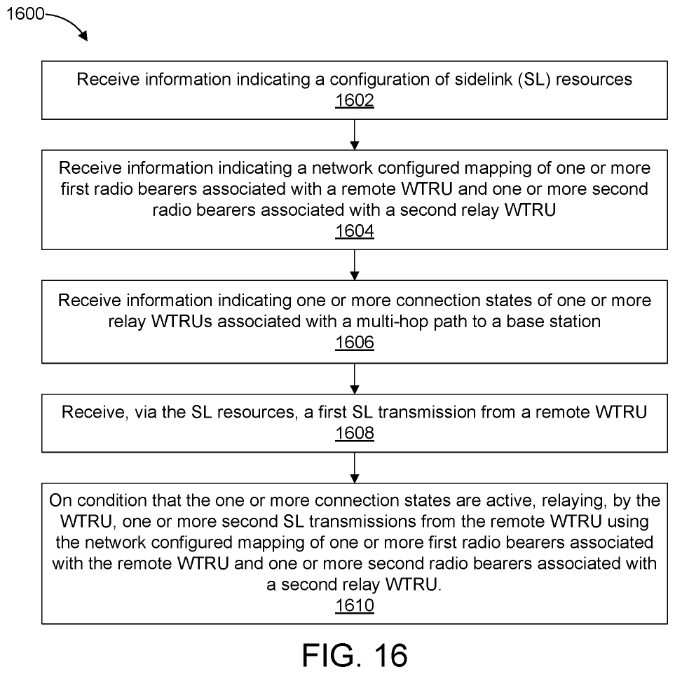

FIG. 16 is a diagram illustrating a representative embodiment of another multi-hop relay communication procedure 1600. The multi-hop relay communication procedure 1600 may be implemented by a WTRU 102. For example, the WTRU 102 may serve as a relay WTRU (e.g., a first relay WTRU 204-1, second relay WTRU 204-2, etc.) on a multi-hop path between a remote WTRU 202 and a base station (e.g., gNB 180 of a RAN 104/113). One or more other (e.g., intermediate) relay WTRUs may be disposed as part of the multi-hop path between the relay WTRU 204-1 and the remote WTRU 202 and/or the relay WTRU 204-2 and the base station. At 1602, the WTRU 102 may receive information indicating a configuration of sidelink (SL) resources. The WTRU 102 may receive information indicating a network configured mapping at 1604. For example, the network configured mapping may be a dedicated adaptation layer configuration as described herein. As one example, the configured mapping may associate one or more first radio bearers (e.g., SRBs and/or DRBs) associated with a remote WTRU 202 and one or more second radio bearers associated with a second relay WTRU 204-2. At 1606, the (e.g., first relay) WTRU 102 may receive information indicating (or determine) one or more connection states (e.g., RRC_CONNECTED, RRC_IDLE, RRC_INACTIVE) of one or more relay WTRUs 204-n associated with the multi-hop path to the base station. At 1608, the (e.g., first relay) WTRU 102 may receive, via the SL resources, a first SL transmission from a remote WTRU 202. After 1608, the (e.g., first relay) WTRU 102, on condition that the one or more connection states are active, may relay (e.g., to a next hop parent relay WTRU) one or more second SL transmissions (e.g., received) from the remote WTRU 202 using the network configured mapping.

In certain representative embodiments, the (e.g., first relay) WTRU 102 may receive information indicating a default mapping (e.g., a default adaptation layer configuration). For example, the indicated default mapping may be received with or before receiving the network configured mapping.

For example, the default mapping may be a default adaptation layer configuration and/or the network configured mapping may be a dedicated adaptation layer configuration. For example, the default and/or network configured mapping may associate ingress channels (e.g., SL RLC, Uu RLC IDs) with egress channels, ingress properties with egress properties, and/or prioritization of ingress to egress (e.g., a priority of the one or more first radio bearers to one of the one or more second radio bearers). Examples of default and dedicated adaptation layer configurations are described elsewhere herein.

In certain representative embodiments described herein, multi-hop relay communication procedures may be implemented (e.g., separately or in combination with other WTRUs) by a WTRU 102. For example, the WTRU 102 may be a first or an intermediate relay WTRU 204-1, 204-2, 204-n, on a multi-hop path to a base station, for one or more remote WTRUs 202.

In certain representative embodiments, a multi-hop relay communication procedure may be implemented by a WTRU 102. The (e.g., relay) WTRU 102 may receive (e.g., from another relay WTRU) information indicating a weight value associated with a multi-hop path to a base station and/or a radio connection state of each hop along the multi-hop path. The WTRU 102 may measure a channel busy ratio of an ingress and/or egress sidelink (SL) radio link control (RLC) channel associated with the multi-hop path. The WTRU 102 may receive a radio connection request from a remote WTRU 202 having an inactive radio connection (e.g., RRC_INACTIVE). The WTRU 102 may determine a QoS associated with the (e.g., ingress) SL RLC channel.

For example, on condition that the measured CBR is above a threshold associated with the QoS and the weight value, the WTRU 102 may initiate, after receiving the radio connection request from the remote WTRU 202, a radio connection establishment procedure with the base station. On condition that a radio connection to the base station is successfully established within a time interval from a start of the radio connection establishment procedure plus a time value, the WTRU 102 may perform relaying of at least the ingress SL RLC channel to an egress SL RLC channel according to a configured mapping. For example, the configured mapping may associate the ingress SL RLC channel to the egress SL RLC channel.

In certain representative embodiments, a multi-hop relay communication procedure may be implemented by a WTRU 102. The (e.g., relay) WTRU 102 may receive (e.g., from another relay WTRU) information indicating a weight value associated with a multi-hop path to a base station and/or a radio connection state of each hop along the multi-hop path. The WTRU 102 may measure a channel busy ratio of an ingress and/or egress sidelink (SL) radio link control (RLC) channel associated with the multi-hop path. The WTRU 102 may receive a radio connection request from a remote WTRU 202 having an inactive radio connection (e.g., RRC_INACTIVE). The WTRU 102 may determine a QoS associated with the (e.g., ingress) SL RLC channel and/or the remote WTRU 202.

For example, on condition that the measured CBR is above a threshold associated with the QoS and the weight value, the WTRU 102 may initiate, after receiving the radio connection request from the remote WTRU 202, a radio connection establishment procedure with the base station. On condition that a time interval from a start of the radio connection establishment procedure plus a time value has elapsed without a radio connection to the base station being successfully established, the WTRU 102 may perform relaying of at least the ingress SL RLC channel to the egress SL RLC channel according to a default mapping. As an example, the default mapping may associate a priority of the ingress SL RLC channel to the egress SL RLC channel.

For example, the radio connection request may be a radio connection establishment (or reestablishment) request.

For example, the radio connection request maybe received via another relay WTRU using the ingress SL RLC channel.

For example, the radio connection request may be received from the remote WTRU 202 using the ingress SL RLC channel.

For example, the WTRU 102 may receive, from the base station, information indicating a configuration of the ingress SL RLC channel and/or the egress SL RLC channel.

For example, the WTRU 102 may receive, from the remote WTRU 202, information indicating a configuration of the ingress SL RLC channel and/or the egress SL RLC channel.

For example, the time value may be configured or determined based on the weight value associated with the multi-hop path and/or the radio connection state of each hop along the multi-hop path.

For example, the radio connection request from the remote WTRU 202 may include information indicating to initiate the radio connection establishment procedure.

For example, before receiving the radio connection request from the remote WTRU 202, the WTRU 102 may receive information indicating the configured mapping.

For example, after performing the relaying of at least the ingress SL RLC channel to the egress SL RLC channel according to the configured mapping, the WTRU 102 may perform relaying of at least the ingress SL RLC channel to another egress SL RLC channel according to a default mapping. As an example, the default mapping may associate a priority of the ingress SL RLC channel to the other egress SL RLC channel.

For example, after performing the relaying of at least the ingress SL RLC channel to the egress SL RLC channel according to the network configured mapping and after a failure associated with the egress SL RLC channel occurs, the WTRU 102 may perform relaying of at least the ingress SL RLC channel to another egress SL RLC channel according to a default mapping.

For example, after performing the relaying of at least the ingress SL RLC channel to the egress SL RLC channel according to the network configured mapping and after performing a cell reselection procedure, the WTRU 102 may perform relaying of at least the ingress SL RLC channel to another egress SL RLC channel according to a default mapping.

For example, after performing the relaying of at least the ingress SL RLC channel to the egress SL RLC channel according to the network configured mapping and after the radio connection is released, the WTRU 102 may perform relaying of at least the ingress SL RLC channel to another egress SL RLC channel according to a default mapping.

For example, the WTRU 102 may receive (e.g., from the base station) broadcast system information which includes information indicating the default mapping.

In certain representative embodiments, a vehicle may include the WTRU 102 serving as a relay WTRU.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “WTRU”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented by a wireless transmit/receive unit (WTRU) for multi-hop relay communications, the method comprising:
receiving information indicating a configuration of sidelink (SL) resources;
receiving, via the SL resources, a first SL transmission from a remote WTRU;
initiating, by the WTRU as a first relay WTRU, a connection establishment procedure to a base station;
determining, by the first relay WTRU, a failure has occurred in the connection establishment procedure; and
sending, by the first relay WTRU via the SL resources, a second SL transmission to the remote WTRU, wherein the second SL transmission includes information indicating a reason for the failure in the connection establishment procedure is associated with a second relay WTRU.

2. The method of claim 1, wherein the first SL transmission includes information indicating a Uu connection establishment request associated with the remote WTRU.

3. The method claim 1, wherein the determining, by the first relay WTRU, the failure has occurred in the connection establishment procedure includes receiving, by the first relay WTRU, a third transmission including information indicating the failure has occurred in the connection establishment procedure.

4. The method of claim 3, wherein the third transmission includes a PC5 failure message having information indicating the failure in the connection establishment procedure is associated with the second relay WTRU.

5. The method of claim 3, wherein the third transmission includes information indicating the second relay WTRU as a source of the failure in the connection establishment procedure.

6. The method of claim 1, wherein the determining, by the first relay WTRU, the failure has occurred in the connection establishment procedure includes receiving, by the first relay WTRU, a third transmission associated with a PC5 protocol stack.

7.-8. (canceled)

9. The method of claim 1, wherein the second SL transmission includes the information indicating the reason for the failure in the connection establishment procedure is associated with the second relay WTRU as a source of the failure.

10. (canceled)

11. The method of claim 1, wherein the determining, by the first relay WTRU, the failure has occurred in the connection establishment procedure includes determining a time interval beginning with the initiating of the connection establishment procedure has lapsed prior to receiving any of a connection setup message, a connection establishment message, and/or a connection resume message.

12. A wireless transmit/receive unit (WTRU) comprising:
a processor and a transceiver which are configured to:
receive information indicating a configuration of sidelink (SL) resources,
receive, via the SL resources, a first SL transmission from a remote WTRU,
initiate, by the WTRU as a first relay WTRU, a connection establishment procedure to a base station,
determine, by the first relay WTRU, that a failure has occurred in the connection establishment procedure, and
send, by the first relay WTRU via the SL resources, a second SL transmission to the remote WTRU, wherein the second SL transmission includes information indicating a reason for the failure in the connection establishment procedure is associated with a second relay WTRU.

13. The WTRU of claim 12, wherein the first SL transmission includes information indicating a Uu connection establishment request associated with the remote WTRU.

14. The WTRU of any of claim 12, wherein the processor and the transceiver are configured to receive, as the first relay WTRU, a third transmission including information indicating the failure has occurred in the connection establishment procedure and determine the failure has occurred in the connection establishment procedure based on the information included in the third transmission.

15. The WTRU of claim 14, wherein the third transmission includes a PC5 failure message having information indicating the failure in the connection establishment procedure is associated with the second relay WTRU.

16. The WTRU of claim 14, wherein the third transmission includes information indicating the second relay WTRU as a source of the failure in the connection establishment procedure.

17. The WTRU of any of claim 12, wherein the processor and the transceiver are configured to receive a third transmission associated with a PC5 protocol stack and determine the failure has occurred in the connection establishment procedure based on the third transmission.

18.-19. (canceled)

20. The WTRU of claim 12, wherein the second SL transmission includes the information indicating the reason for the failure in the connection establishment procedure is associated with the second relay WTRU as a source of the failure.

21. (canceled)

22. The WTRU of claim 12, wherein the processor and the transceiver are configured to determine the failure has occurred in the connection establishment procedure by determining a time interval beginning with the initiation of the connection establishment procedure has lapsed prior to receiving any of a connection setup message, a connection establishment message, and/or a connection resume message.

23.-33. (canceled)
